(19) United States
(12) Patent Application Publication
(10) Pub. No.: US 2025/0220578 A1
(43) Pub. Date: Jul. 3, 2025

(54) LOW POWER WAKE UP SIGNAL SKIPPING

(71) Applicant: QUALCOMM Incorporated, San Diego, CA (US)

(72) Inventors: Hemant SAGGAR, San Diego, CA (US); Sony AKKARAKARAN, Poway, CA (US); Igor GUTMAN, Hod HaSharon (IL); Navid ABEDINI, Basking Ridge, NJ (US); Tao LUO, San Diego, CA (US)

(21) Appl. No.: 18/403,016

(22) Filed: Jan. 3, 2024

(51) Int. Cl. H04W 52/02

(52) U.S. Cl. CPC H04W 52/0229; H04W 52/0216

(57) ABSTRACT

Methods, systems, and devices for wireless communications are described. A user equipment (UE) may receive, via a low power radio of the UE or a main radio of the UE, a signal indicative that the UE is to skip use of the low power radio to monitor one or more low power wake up signals. In some examples, the signal may be a low power wake up signal that is indicative of a payload. The payload may indicate a skipping pattern or skipping duration. In some examples, the signal may be a control signal, such as downlink control information. The UE may skip monitoring of the one or more low power wake up signals based on the signal.

### FIELD OF TECHNOLOGY

The following relates to wireless communications, including low power wake up signal skipping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support low power wake up signal skipping. For example, the described techniques provide for a user equipment (UE) to skip use of a low power radio of the UE to monitor for low power wake up signals. A network entity may transmit a signal indicating for the UE to skip monitoring low power wake up signals. In some examples, a network entity may transmit a low power wake up signal indicative that the UE is to skip monitoring for low power wake up signals. For example, a sequence carried by the low power wake up signal or the resources used to transmit the low power wake up signal may indicate for the UE to skip monitoring for low power wake up signals. In some examples, the network entity may transmit control signaling for the main radio of the UE indicating for the UE to skip the low power wake up signals. The network entity may indicate for the UE to skip monitoring for low power wake up signals according to a certain pattern or periodicity. For example, the network entity may indicate for the UE to monitor every fourth low power wake up signal occasion (e.g., skipping monitoring each other low power wake up signal occasion), or the network entity may indicate for the UE to skip monitoring an indicated quantity of DRX cycles for low power wake up signals. In some examples, the UE may transmit a request to skip monitoring low power wake up occasions based on battery power of the UE or traffic conditions at the UE. These techniques may reduce power consumption at the UE, as the UE may spend less energy monitoring for low power wake up signals.

A method for wireless communications by a UE is described. The method may include receiving, via a low power radio of the UE or a main radio of the UE a signal indicative that the UE is to skip use of the low power radio to monitor one or more low power wake up signals and skipping monitoring of the one or more low power wake up signals based on the signal.

A UE for wireless communications is described. The UE may include one or more memories storing processor executable code, and one or more processors coupled with the one or more memories. The one or more processors may individually or collectively operable to execute the code to cause the UE to receive, via a low power radio of the UE or a main radio of the UE a signal indicative that the UE is to skip use of the low power radio to monitor one or more low power wake up signals and skip monitoring of the one or more low power wake up signals based on the signal.

Another UE for wireless communications is described. The UE may include means for receiving, via a low power radio of the UE or a main radio of the UE a signal indicative that the UE is to skip use of the low power radio to monitor one or more low power wake up signals and means for skipping monitoring of the one or more low power wake up signals based on the signal.

A non-transitory computer-readable medium storing code for wireless communications is described. The code may include instructions executable by one or more processors to receive, via a low power radio of the UE or a main radio of the UE a signal indicative that the UE is to skip use of the low power radio to monitor one or more low power wake up signals and skip monitoring of the one or more low power wake up signals based on the signal.

In some examples of the method, UEs, and non-transitory computer-readable medium described herein, receiving the signal may include operations, features, means, or instructions for receiving, via the low power radio of the UE, a low power wake up signal indicative that the UE may be to skip use of the low power radio to monitor the one or more low power wake up signals.

In some examples of the method, UEs, and non-transitory computer-readable medium described herein, the low power wake up signal may be received via one or more resources and one or more indexes of the one or more resources indicate to skip use of the low power radio to monitor the one or more low power wake up signals.

In some examples of the method, UEs, and non-transitory computer-readable medium described herein, the one or more resources correspond to time resources, frequency resources, spatial resources, or any combination thereof.

Some examples of the method, UEs, and non-transitory computer-readable medium described herein may further include operations, features, means, or instructions for receiving control signaling indicating a set of multiple resources including the one or more resources and monitoring for the low power wake up signal via the set of multiple resources based on the control signaling.

In some examples of the method, UEs, and non-transitory computer-readable medium described herein, the low power wake up signal includes one or more modulated bits indicative that the UE may be to skip use of the low power radio to monitor the one or more low power wake up signals.

Some examples of the method, UEs, and non-transitory computer-readable medium described herein may further include operations, features, means, or instructions for detecting the low power wake up signal using an envelope detector.

In some examples of the method, UEs, and non-transitory computer-readable medium described herein, the low power wake up signal includes a sequence and a sequence index of the sequence indicates to skip use of the low power radio to monitor the one or more low power wake up signals.

Some examples of the method, UEs, and non-transitory computer-readable medium described herein may further include operations, features, means, or instructions for receiving control signaling indicating one or more sequence indexes including at least the sequence index and one or more corresponding sets of wake up signal skipping parameters.

In some examples of the method, UEs, and non-transitory computer-readable medium described herein, the low power wake up signal indicates an identifier of the UE, a group identifier corresponding to a set of multiple UEs, a cell identifier, a tracking area identifier, or any combination thereof.

In some examples of the method, UEs, and non-transitory computer-readable medium described herein, receiving the signal may include operations, features, means, or instructions for receiving, via the main radio of the UE, a control signal indicative that the UE may be to skip use of the low power radio to monitor the one or more low power wake up signals.

Some examples of the method, UEs, and non-transitory computer-readable medium described herein may further include operations, features, means, or instructions for receiving a low power wake up signal during a low power wake up signal monitoring occasion indicated by the control signal, where powering down the low power radio may be based on receiving the low power wake up signal.

Some examples of the method, UEs, and non-transitory computer-readable medium described herein may further include operations, features, means, or instructions for powering down the main radio based on receiving the control signal without receiving a downlink data message associated with the control signal.

In some examples of the method, UEs, and non-transitory computer-readable medium described herein, skipping the monitoring may include operations, features, means, or instructions for skipping the monitoring of the one or more low power wake up signals based on non-receipt of a threshold quantity of consecutive low power wake up signals.

In some examples of the method, UEs, and non-transitory computer-readable medium described herein, the signal indicates a pattern for skipping monitoring of the one or more low power wake up signals, a duration for skipping monitoring of the one or more low power wake up signals, or one or more low power wake up signal monitoring occasions, or any combination thereof.

In some examples of the method, UEs, and non-transitory computer-readable medium described herein, skipping the monitoring may include operations, features, means, or instructions for skipping a set of multiple low power wake up signals, where the signal may be indicative of a quantity of the set of multiple low power wake up signals.

Some examples of the method, UEs, and non-transitory computer-readable medium described herein may further include operations, features, means, or instructions for receiving an indication to resume monitoring of low power wake up signals and monitoring for the low power wake up signals based on the indication to resume monitoring.

Some examples of the method, UEs, and non-transitory computer-readable medium described herein may further include operations, features, means, or instructions for transmitting a request for the signal indicative that the UE may be to skip use of the low power radio to monitor the one or more low power wake up signals, where the signal may be received based on the request.

In some examples of the method, UEs, and non-transitory computer-readable medium described herein, the request may be transmitted based on a battery state of the UE, traffic conditions at the UE, or both.

A method for wireless communications by a network entity is described. The method may include transmitting, to a UE equipped with a low power radio and a main radio, a signal indicative that the UE is to skip use of the low power radio to monitor one or more low power wake up signals and refraining from transmitting the one or more low power wake up signals to the low power radio of the UE based on transmitting the signal.

A network entity for wireless communications is described. The network entity may include one or more memories storing processor executable code, and one or more processors coupled with the one or more memories. The one or more processors may individually or collectively operable to execute the code to cause the network entity to transmit, to a UE equipped with a low power radio and a main radio, a signal indicative that the UE is to skip use of the low power radio to monitor one or more low power wake up signals and refrain from transmitting the one or more low power wake up signals to the low power radio of the UE based on transmitting the signal.

Another network entity for wireless communications is described. The network entity may include means for transmitting, to a UE equipped with a low power radio and a main radio, a signal indicative that the UE is to skip use of the low power radio to monitor one or more low power wake up signals and means for refraining from transmitting the one or more low power wake up signals to the low power radio of the UE based on transmitting the signal.

A non-transitory computer-readable medium storing code for wireless communications is described. The code may include instructions executable by one or more processors to transmit, to a UE equipped with a low power radio and a main radio, a signal indicative that the UE is to skip use of the low power radio to monitor one or more low power wake up signals and refrain from transmitting the one or more low power wake up signals to the low power radio of the UE based on transmitting the signal.

In some examples of the method, network entities, and non-transitory computer-readable medium described herein, transmitting the signal may include operations, features, means, or instructions for transmitting, to the low power radio of the UE, a low power wake up signal indicative that the UE may be to skip use of the low power radio to monitor the one or more low power wake up signals.

In some examples of the method, network entities, and non-transitory computer-readable medium described herein, the low power wake up signal may be transmitted via one or more resources and one or more indexes of the one or more resources indicate to skip use of the low power radio to monitor the one or more low power wake up signals.

In some examples of the method, network entities, and non-transitory computer-readable medium described herein, the one or more resources correspond to time resources, frequency resources, spatial resources, or any combination thereof.

Some examples of the method, network entities, and non-transitory computer-readable medium described herein may further include operations, features, means, or instructions for transmitting control signaling indicating a set of multiple resources including the one or more resources, where the low power wake up signal may be transmitted via the one or more resources based on the control signaling.

In some examples of the method, network entities, and non-transitory computer-readable medium described herein, the low power wake up signal includes a sequence and a sequence index of the sequence indicates to skip use of the low power radio to monitor the one or more low power wake up signals.

Some examples of the method, network entities, and non-transitory computer-readable medium described herein may further include operations, features, means, or instructions for transmitting control signaling indicating one or more sequence indexes including at least the sequence index and one or more corresponding sets of wake up signal skipping parameters.

In some examples of the method, network entities, and non-transitory computer-readable medium described herein, the low power wake up signal indicates an identifier of the UE, a group identifier corresponding to a set of multiple UEs, a cell identifier, a tracking area identifier, or any combination thereof.

In some examples of the method, network entities, and non-transitory computer-readable medium described herein, transmitting the signal may include operations, features, means, or instructions for transmitting, to the main radio of the UE, a control signal indicative that the UE may be to skip use of the low power radio to monitor the one or more low power wake up signals.

Some examples of the method, network entities, and non-transitory computer-readable medium described herein may further include operations, features, means, or instructions for transmitting a low power wake up signal during a low power wake up signal monitoring occasion, where the control signal indicates the low power wake up signal monitoring occasion.

In some examples of the method, network entities, and non-transitory computer-readable medium described herein, the signal indicates a pattern for skipping monitoring of the one or more low power wake up signals, a duration for skipping monitoring of the one or more low power wake up signals, or one or more low power wake up signal monitoring occasions, or any combination thereof.

Some examples of the method, network entities, and non-transitory computer-readable medium described herein may further include operations, features, means, or instructions for receiving a request for the signal indicative that the UE may be to skip use of the low power radio to monitor the one or more low power wake up signals, where the signal may be transmitted based on the request.

In some examples of the method, network entities, and non-transitory computer-readable medium described herein, the request indicates a battery state of the UE, traffic conditions at the UE, or both.

### BRIEF DESCRIPTION OF THE DRAWINGS

FIG. 1 shows an example of a wireless communications system that supports low power wake up signal skipping in accordance with one or more aspects of the present disclosure.

FIG. 2 shows an example of a wireless communications system that supports low power wake up signal skipping in accordance with one or more aspects of the present disclosure.

FIG. 3 shows an example of a skipping indication that supports low power wake up signal skipping in accordance with one or more aspects of the present disclosure.

FIG. 4 shows examples of skipping configurations that support low power wake up signal skipping in accordance with one or more aspects of the present disclosure.

FIG. 5 shows an example of a skipping indication that supports low power wake up signal skipping in accordance with one or more aspects of the present disclosure.

FIG. 6 shows examples of skipping indications that support low power wake up signal skipping in accordance with one or more aspects of the present disclosure.

FIG. 7 shows an example of a process flow that supports low power wake up signal skipping in accordance with one or more aspects of the present disclosure.

FIGS. 8 and 9 show block diagrams of devices that support low power wake up signal skipping in accordance with one or more aspects of the present disclosure.

FIG. 10 shows a block diagram of a communications manager that supports low power wake up signal skipping in accordance with one or more aspects of the present disclosure.

FIG. 11 shows a diagram of a system including a device that supports low power wake up signal skipping in accordance with one or more aspects of the present disclosure.

FIGS. 12 and 13 show block diagrams of devices that support low power wake up signal skipping in accordance with one or more aspects of the present disclosure.

FIG. 14 shows a block diagram of a communications manager that supports low power wake up signal skipping in accordance with one or more aspects of the present disclosure.

FIG. 15 shows a diagram of a system including a device that supports low power wake up signal skipping in accordance with one or more aspects of the present disclosure.

FIGS. 16 through 19 show flowcharts illustrating methods that support low power wake up signal skipping in accordance with one or more aspects of the present disclosure.

### DETAILED DESCRIPTION

A user equipment (UE) may be equipped with a low power radio and a main radio. The UE may operate in a low power state and monitor for low power wake up signals using the low power radio. For example, the UE may monitor for the low power wake up signals during an “on” duration of a discontinuous reception (DRX) cycle. When the UE receives the low power wake up signal, the UE may power the main radio to transmit or receive signaling using the main radio. In some cases, the UE may operate according to a connected mode DRX cycle with a short periodicity, such that the UE may frequently wake up the low power radio to monitor for low power wake up signals. While monitoring using the low power radio may use less power than monitoring using the main radio, frequent use of the low power radio to monitor for low power wake up signals, even when there is no traffic for the UE, may increase power consumption at the UE.

A network entity may indicate for a UE to skip use of the low power radio to monitor for low power wake up signals. In some examples, the network entity may transmit a low power wake up signal which indicates for the UE to skip monitoring for low power wake up signals. For example, a sequence carried by the low power wake up signal or the resources used to transmit the low power wake up signal may indicate for the UE to skip monitoring for low power wake up signals. In some examples, the network entity may transmit control signaling for the main radio of the UE, and the control signaling may indicate for the UE to skip monitoring the low power wake up signals. The network entity may indicate for the UE to skip monitoring for low power wake up signals according to a certain pattern or periodicity. For example, the network entity may indicate for the UE to monitor every fourth DRX cycle (e.g., skipping monitoring each DRX cycle), or the network entity may indicate for the UE to skip monitoring the next NDRX cycles. In some examples, the UE may transmit a request to skip monitoring based on battery power of the UE or traffic conditions at the UE. These techniques may reduce power consumption at the UE, as the UE may spend energy monitoring for low power wake up signals.

Aspects of the disclosure are initially described in the context of wireless communications systems. Aspects of the disclosure are further illustrated by and described with reference to apparatus diagrams, system diagrams, and flowcharts that relate to low power wake up signal skipping.

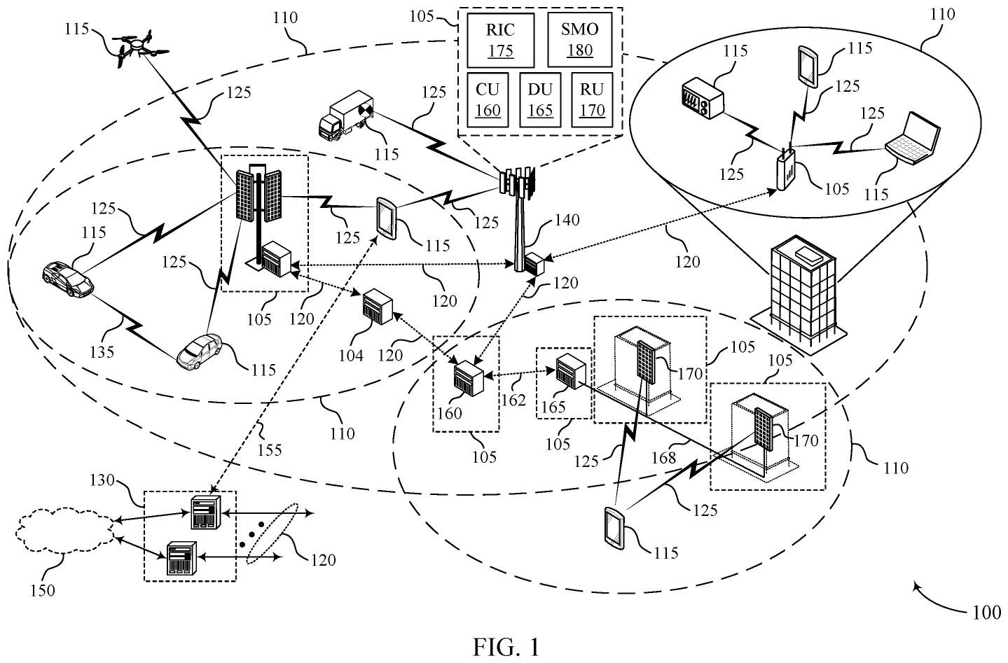

FIG. 1 shows an example of a wireless communications system 100 that supports low power wake up signal skipping in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support low power wake up signal skipping as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of TS=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications system, such as an IoT system, a UE 115 may operate in an idle mode, where power consumption at the UE 115 is mostly spent monitoring for paging signaling. Some wireless communications systems may support a low power wake up signal, and UEs 115 may be equipped with low power radios or low power receivers. The low power radio may use significantly less power than the main radio. A UE 115 may use the low power radio to monitor for a low power wake up signal instead of downlink control information and continue to sleep or operate in a low power mode until the UE 115 receives the low power wake up signal. The UE 115 may also monitor for other low power signaling using the low power radio, such as a low power synchronization signal. In some examples, using the low power radio to monitor for the low power wake up signal may provide power savings. In some examples, some radio resource management (RRM) techniques or signaling may be performed using the low power radio.

The UE 115 may use the low power radio and low power wake up signal while operating in an idle mode or a connected mode. In some examples, a connected mode DRX periodicity may be faster than an idle mode DRX mode. For example, a connected mode DRX periodicity in Frequency Range 2 may correspond to milliseconds (e.g., 40 milliseconds to 80 milliseconds) while an idle mode DRX periodicity may be a few seconds long. A UE 115 operating according to a connected mode DRX cycle may more frequency monitor for low power wake up signals using the low power radio. However, the UE 115 may not have traffic to transmit or receive. The UE 115 may frequently monitor for a low power wake up signal using the low power radio, but this may waste power consumption, especially if there is little or no traffic for the UE 115.

In wireless communications systems described herein, such as the wireless communications system 100, a network entity 105 may indicate for a UE 115 to skip monitoring of low power wake up signals. For example, the network entity 105 may indicate for the UE 115 to skip monitoring of low power wake up signals for a certain time duration or according to a pattern. The network entity 105 may indicate one-time skipping (e.g., skip monitoring for a low power wake up signal for the next N DRX cycles) or pattern-based skipping (e.g., monitor for a low power wake up signal every Nth DRX cycle and skip monitoring the other DRX cycles).

In some examples, the network entity 105 may transmit a low power wake up signal which indicates for the UE 115 to skip the monitoring. For example, the resources used to transmit the low power wake up signal or a sequence used to transmit the low power wake up signal may indicate information to the UE 115 associated with skipping monitoring of low power wake up signals. In some examples, the low power wake up signal may carry modulated bits indicating information associated with skipping the monitoring. The low power wake up signal may indicate a pattern or interval for skipping monitoring of following low power wake up signals.

In some examples, the network entity 105 may transmit a control signal to the main radio for the UE 115 which indicates information for skipping monitoring of low power wake up signals using the low power radio. For example, the network entity 105 may transmit downlink control information or a MAC message (e.g., a MAC CE) indicating for the UE 115 to skip use of the low power radio to monitor for low power wake up signal. The control signal may indicate a pattern for the skipping or an interval for the skipping.

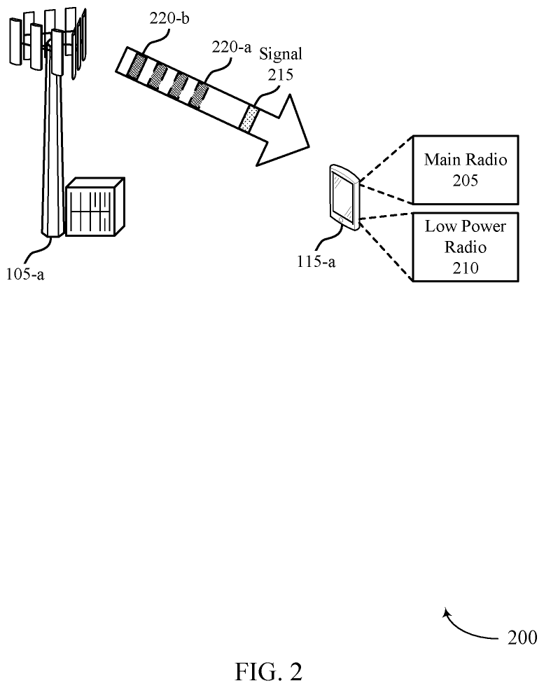

FIG. 2 shows an example of a wireless communications system 200 that supports low power wake up signal skipping in accordance with one or more aspects of the present disclosure. The wireless communications system 200 may implement or be an example of some aspects of the wireless communications system 100. For example, the wireless communications system 200 may include a network entity 105-a and a UE 115-a, which may be respective examples of a network entity 105 and a UE 115 described herein.

The UE 115-a may be equipped with a main radio 205 and a low power radio 210. The UE 115-a may use the main radio 205 for higher layer signaling (e.g., RRC signaling) and lower layer signaling (e.g., physical layer signaling), such as control and data signaling. The UE 115-a may use the low power radio 210 to monitor for low power signaling, such as low power wake up signals and low power synchronization signals. In some examples, the UE 115-a may use the low power radio 210 while the main radio 205 is put to sleep to save power. In some cases, the UE 115-a may use the low power radio 210 and the main radio 205 at the same time to improve a processing capability of the UE 115-a.

The wireless communications system 200 may support techniques for the UE 115-a to skip monitoring for low power wake up signals. For example, if there is little or no traffic for the UE 115-a, the network entity 105-a may transmit a signal 215 indicating for the UE 115-a to skip use of the low power radio 210 for monitoring low power wake up signals. In idle or low traffic periods, the network entity 105-a may dynamically indicate for the UE 115-a to not expect a wake up signal, such as during a next duration T or for the next NDRX cycles, which may enable the UE 115-a to enter a lower power state or save power by not monitoring using the low power radio 210.

For example, the network entity 105-a may transmit the signal 215 to the UE 115-a, and the signal 215 may indicate for the UE 115-a to skip monitoring for a low power wake up signal using the low power radio 210 in a next three DRX cycles. For example, the UE 115-a may skip monitoring for a low power wake up signal starting from low power wake up signal monitoring occasion 220-a. After skipping the monitoring for three DRX cycles, the UE 115-a may begin monitoring for the low power wake up signals again. For example, the UE 115-a may monitor for a low power wake up signal during low power wake up signal monitoring occasion 220-b.

In some examples, the signal 215 may indicate a pattern or duration for skipping monitoring of low power wake up signals. For example, the signal 215 may indicate a pattern or a duration for skipping the monitoring. In some examples, the signal 215 may indicate a one-time skipping of monitoring. For example, the signal 215 may indicate a duration of time or a quantity of DRX cycles that the UE 115-a is to skip monitoring for low power wake up signals. For example, the signal 215 may indicate for the UE 115-a to skip monitoring for a low power wake up signal for the next one, two, four, eight, etc., DRX cycles. Additionally, or alternatively, the signal 215 may indicate a pattern, and the UE 115-a may skip monitoring for low power wake up signals according to the pattern. For example, the signal 215 may indicate for the UE 115-a to skip monitoring for the low power wake up signal every other DRX cycle, or the signal may indicate for the UE 115-a to monitor for the low power wake up signal every fourth DRX cycle, and the UE 115-a may skip monitoring for the low power wake up signal for the three DRX cycles between. Other patterns may be configurable, such as monitoring for two DRX cycles then skipping monitoring for two DRX cycles, among others.

In some examples, the signal 215 may indicate when the UE 115-a is to begin skipping monitoring for low power wake up signals using the low power radio 210. For example, the signal 215 may indicate for the UE 115-a to skip monitoring for low power wake up signals according to a pattern of monitoring one out of four monitoring occasions, and the signal 215 may indicate that the UE 115-a is to begin skipping monitoring after two DRX cycles. For example, if the UE 115-a receives the signal 215 associated with a first DRX cycle, the UE 115-a may monitor for a low power wake up signal during a second DRX cycle, a third DRX cycle, a seventh DRX cycle, and an eleventh DRX cycle.

In some examples, the signal 215 may be a low power wake up signal. For example, the network entity 105-a may transmit a low power wake up signal to the UE 115-a, and the low power wake up signal may indicate that the UE 115-a is to skip use of the low power radio 210 for monitoring one or more low power wake up signals. The signal 215 may include, indicate, or be indicative of information, which may be referred to as a payload. In some examples, the payload of the signal 215 may refer to actual information bits carried by the signal 215. Additionally, or alternatively, the payload of the signal 215 may refer to information conveyed based on transmission of the signal 215, characteristics of the signal 215, a sequence of the signal 215, or modulation of the signal 215, or any combination thereof. For example, the low power wake up signal may carry information (e.g., the payload) based on a selected sequence for the low power wake up signal or based on a selection of resources for the low power wake up signal.

In some examples, the payload of the signal 215 may include an identifier of the UE 115-a. For example, the signal 215 may indicate a target-specific identifier of the UE 115-a, or the signal 215 may indicate a UE-group identifier for one or more UEs 115. In some examples, the payload of the signal 215 may include a skipping indication for low power wakeup signal skipping. For example, the payload of the signal 215 may include a type of skipping, a skipping duration, a skipping pattern, or any combination thereof. In some examples, the payload of the signal 215 may include other information, such as a cell identifier (e.g., of the network entity 105-a) or a tracking area identifier.

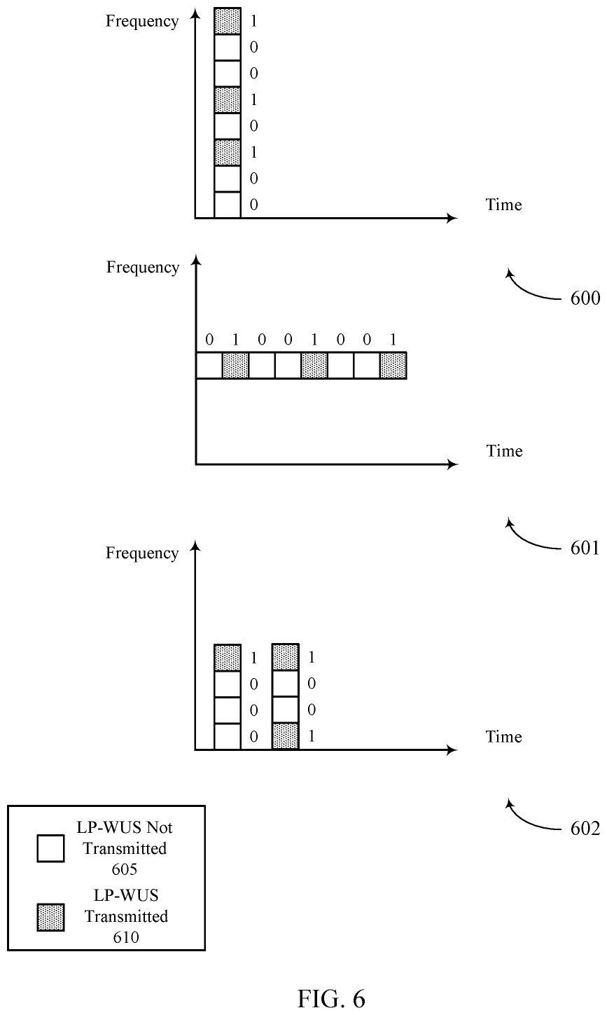

In some examples, the payload of a low power wake up signal (e.g., the signal 215) may be indicated through on/off keying based signaling. For example, a single bit of information may be conveyed by either using or not using a resource. For example, if there are eight resource elements in the frequency domain to transmit the low power wake up signal, and the network entity 105-a may transmit the low power wake up signal on the zeroth and third resource elements and not on the other resource elements. In this example, the first, second, and fourth through seventh resource elements may be off or not used to transmit the low power wake up signal. The payload of the low power wake up signal may correspond to a bit sequence of ‘00001001’. For example, by switching on or off eight resources for transmission of the low power wake up signal, eight bits of information may be conveyed, representing up to 256 different configurations for the payload to indicate information such as the skipping pattern, skipping duration, and the like. An example of indicating the payload of the signal 215 using on/off keying is described in more detail with reference to FIG. 6.

In some examples, the payload of a low power wake up signal (e.g., the signal 215) may be indicated through index modulation. For example, information may be embedded in or correspond to a choice of resources used for communication. For example, a choice of frequency resources, time resources, antenna selection, or port selection may be indicative of the payload of the signal 215. For example, the network entity 105-a may select one configuration out of 2^{N} configurations (e.g., frequency resources, time resources, antenna selections, port selections, etc.), and the selected configuration may indicate N bits. For example, if there are eight possible configurations, the selected configuration may convey three bits. If there are four (2²) frequency resources available for transmitting the low power wake up signal, and the network entity 105-a select the first frequency resource (e.g., f₁), this may indicate a two bit sequence of ‘01’. In some examples, the frequency resources may be frequency sub-bands. The UE 115-a may receive the low power wake up signal and detect the payload of the low power wake up signal using an envelope detector or an energy detector. In some examples, the UE 115-a may use either coherent (e.g., channel-phase based) or non-coherent (e.g., received energy based) techniques to detect on-off keying and index modulation. In some examples, coherent techniques may provide an enhanced signal-to-noise ratio but at a higher complexity and power consumption.

In some examples, the payload of a low power wake up signal (e.g., the signal 215) may be indicated through a sequence index. For example, information or the payload may be conveyed using the index of the sequence used for the low power wake up signal. The sequence may be repeated over multiple time, frequency, or antenna port resources, which may provide enhanced coverage. The sequence may be, for example, a Zadoff-Chu sequence, a Golay sequence, an m-sequence, or a binary sequence. In some examples, the network entity 105-a may configure the UE 115-a with a list of sequences, and the UE 115-a may monitor for sequences in the list. In some examples, the UE 115-a may use one or more correlators to detect the sequences. For example, the UE 115-a may receive the signal 215 and may perform front-end processing on the signal 215. The UE 115-a may compare the received signal to different sequences. For example, the UE 115-a may compare the received signal to a first known sequence using a first correlator, and the UE 115-a may compare the received signal to a second known sequence using a second correlator. The UE 115-a may compare the correlations to the different known sequences to each other or to a threshold. If a correlation between the signal 215 and a known sequence satisfies a threshold, the UE 115-a may de-map the bits corresponding to the sequence index. For example, there may be 4 different sequences which may indicate four different choices, or two bits. In some examples, sequence index, index modulation, on/off keying, or any combination thereof, be used to indicate additional information. For example, the sequence index may correspond to an additional configuration for index modulation.

In some examples, the payload of a low power wake up signal (e.g., the signal 215) may be indicated through modulated bits. For example, the low power wake up signal may be arbitrary modulated bits from a known constellation, such as quadrature amplitude modulation (QAM). A receiver, such as the UE 115-a, may be trained on bits or samples to estimate the channel before demodulating bits of the low power wake up signal. The training bits or training samples may be included with the low power wake up signal or may be sent on a different sequence or different signal. The UE 115-a may receive the low power wake up signal, equalize the estimated channel, demodulate the low power wake up signal and decode the bits. In some examples, the UE 115-a may use an in-phase/quadrature based receiver to receive the low power wake up signal. For example, the network entity 105-a may generate a bit sequence (e.g., b₀, b₁, b₂, b₃) and map modulated symbols to antenna ports of the network entity 105-a. The network entity 105-a may perform a DFT or inverse Fast Fourier Transform (IFFT) and transmit the low power wake up signal to the UE 115-a. The UE 115-a may receive the low power wake up signal and perform an inverse DFT (IDFT) or FFT on the received signal, perform channel estimation and equalization using reference symbols, and de-map the bits to obtain the information bits of the low power wake up signal.

In some examples, a low power wake up signal used for the signal 215 may update the skipping pattern but not wake up the main radio of the UE 115-a. A payload of the low power wake up signal may update the skipping pattern, duration, or configuration, but the low power wake up signal may not wake the UE 115-a up. For example, a first low power wake up signal may indicate for the UE 115-a to wake up for the present DRX cycle and monitor for every second low power wake up signal. After a few DRX cycles, a data buffer at the UE 115-a or the network entity 105-a may be exhausted (e.g., there may be no additional traffic for the UE 115-a), and the network entity 105-a may transmit a second low power wake up signal which does not wake the UE 115-a up and configures the UE 115-a to monitor for every fourth low power wake up signal. In some examples, low power wake up signals that wake up the main radio 205 at the UE 115-a may have different sequences than low power wake up signals that do not wake up the main radio 205 at the UE 115-a. Additionally, or alternatively, low power wake up signals that wake up the main radio 205 at the UE 115-a may be modulated differently or transmitted using different resources than low power wake up signals that do not wake up the main radio 205 at the UE 115-a

In some examples, there may be a low power wake up signal monitoring periodicity for the pattern, or a default low power wake up signal monitoring periodicity. The periodicity may be the DRX periodicity (e.g., connected DRX periodicity) or a different periodicity configured by the network entity 105-a. For example, the network entity 105-a may transmit an indication of the periodicity for the low power wake up signal monitoring, such as via control signaling or the signal 215. If a low power wake up signal indicates for the UE 115-a to wake up the main radio (e.g., if data arrives for the UE 115-a), the periodicity for monitoring for low power wake up signals may revert to the default monitoring periodicity. Additionally, or alternatively, the low power wake up signal that wakes up the main radio at the UE 115-a may indicate a different periodicity for monitoring for low power wake up signals.

The UE 115-a may be configured with some skipping configurations. In some examples, the network entity 105-a may transmit control signaling indicating one or more skipping configurations and corresponding payloads. For example, the UE 115-a may be configured with a skipping configuration that corresponds to a first bit sequence. If a payload of a low power wake up signal is indicative of a first bit sequence, the UE 115-a may perform low power wake up signal monitoring (e.g., or the skipping of monitoring) according to a skipping configuration that corresponds to the first bit sequence. For example, there may be eight different bit sequences for the payload of a low power wake up signal, and the UE 115-a may be configured with eight different skipping configurations that correspond to the eight different bit sequences. For example, a first skipping configuration may indicate to start monitoring for a low power wake up sequence in each DRX cycle but not to wake up the main radio 205, a second skipping configuration may indicate not to wake up the main radio and to start skipping each DRX cycle except for every fourth DRX cycle (e.g., monitoring for a low power wake up signal in every fourth DRX cycle), and a third skipping configuration may indicate to skip monitoring for a low power wake up signal for the next four DRX cycles. Other skipping configurations or quantities of skipping configurations are also supported.

In some examples, the UE 115-a may be configured with how to interpret the payload. For example, the UE 115-a may be configured to interpret a payload from a low power wake up signal. For example, a payload of a low power wake up signal may be conveyed via sequence modulation and index modulation, and the selections between sequence modulation and index modulation may correspond to different bits of the payload. The UE 115-a may be configured to interpret, for example, the sequence as the most-significant bits of the payload and the index modulation as the least-significant bits of the payload. In some examples, the network entity 105-a may configure the UE 115-a to interpret the payload of the low power wake up signal.

In some examples, the UE 115-a may be configured with or indicated a set of resources, such as if the low power wake up signal conveys a payload using index modulation or on/off keying. In some examples, the UE 115-a may be configured with or indicated a set of sequences, such as if the low power wake up signal conveys a payload using sequence index or sequence selection. In some examples, the network entity 105-a may transmit signaling to the UE 115-a to indicate or configure the resources or sequences, or both. In some examples, the signaling may indicate a mapping between the sequences or resources, or both, to bit patterns or skipping configurations, or both.

The UE 115-a may transmit a request to skip monitoring of low power wake up signals. For example, the UE 115-a may transmit, to the network entity 105-a, a request to skip monitoring of low power wake up signals according to a skipping pattern or for a duration. In some examples, the request may indicate or identify the skipping pattern or the duration. The request may be based on traffic at the UE 115-a, traffic patterns of the UE 115-a, battery conditions at the UE 115-a, or expected battery conditions at the UE 115-a, or any combination thereof. In some examples, the network entity 105-a may transmit the signal 215 in response to the request. The skipping configuration or payload of the signal 215 may be based on the requested skipping pattern or duration.

In some examples, the signal 215 may be transmitted via control signaling, such as downlink control information or MAC signaling, such as a MAC CE. For example, the network entity 105-a may transmit downlink control information to the UE 115-a that indicates the UE 115-a is to skip use of the low power radio 210 for monitoring one or more low power wake up signals. The signal 215 may, for example, be a downlink grant, a dedicated downlink control information, or a dedicated MAC CE which indicates information for skipping the monitoring of one or more low power wake up signals. The signal 215 as downlink control information or a MAC CE may include similar information as the payload of a low power wake up signal, such as a skipping pattern, a skipping periodicity, a duration for skipping the monitoring, or any combination thereof. In some examples, the network entity 105-a may transmit the signal 215 to the main radio 205 of the UE 115-a when the main radio 205 is already on (e.g., receiving data or available to receive data). The UE 115-a may monitor for the signal 215 along with other data during a connected DRX cycle, including a default ON duration and inactivity timers.

In some examples, the UE 115-a may be configured with a dedicated connected DRX configuration with no or short inactivity timers or a different periodicity for receiving the signal 215 than a default DRX periodicity. The main radio 205 of the UE 115-a may wake up, receive the downlink control information or MAC CE (e.g., the signal 215), and return to sleep without waiting for further downlink signaling reception (e.g., physical downlink control channel (PDCCH) or physical downlink shared channel (PDSCH) reception). The dedicated DRX configuration may use minimal power at the UE 115-a to receive the signal 215.

The network entity 105-a may transmit both a signal for the main radio 205 and a signal for the low power radio 210 to configure the UE 115-a to skip monitoring low power wake up signals. For example, the network entity 105-a may transmit an indication of a portion of the skipping configuration or a low periodicity configuration via downlink control information, while a low power wake up signal may indicate for the UE 115-a to begin skipping. For example, the network entity 105-a may transmit downlink control information to indicate a skipping pattern or duration, and the network entity 105-a may transmit a low power wake up signal (e.g., with a certain sequence or modulation or via certain resources) to indicate that the UE 115-a is to start skipping monitoring for low power wake up signals.

The network entity 105-a may transmit another signal which indicates for the UE 115-a to resume monitoring for low power wake up signals or to stop skipping the monitoring. For example, the network entity 105-a may transmit a low power wake up signal which indicates for the UE 115-a to resume monitoring for low power wake up signals. In some examples, the UE 115-a may detect the low power wake up signal using a detector (e.g., a main radio 205) without waking up the low power radio 210, or the network entity 105-a may transmit the low power wake up signal during a DRX cycle which is monitored by the UE 115-a. In some examples, the network entity 105-a may update the skipping periodicity. For example, the network entity 105-a may change the periodicity at which the UE 115-a monitors DRX cycles for low power wake up signals, such as to monitor every cycle or to monitor at a different periodicity than previously configured.

The network entity 105-a may refrain from transmitting a low power wake up signal to the UE 115-a if the UE 115-a is skipping monitoring for low power wake up signals. For example, the network entity 105-a may configure the UE 115-a to skip monitoring for a low power wake up signal for the next four DRX cycles, and the network entity 105-a may not transmit a low power wake up signal for the next four DRX cycles. For example, the network entity 105-a may have pending data for the UE 115-a after the second DRX cycle that the UE 115-a is skipping. However, because the UE 115-a is skipping monitoring occasions, the network entity 105-a may wait until after the last skipped DRX cycle to transmit the low power wake up signal.

In some examples, the UE 115-a may start to skip monitoring for low power wake up signals based on not detecting a low power wake up signal. For example, if the UE 115-a does not detect or receive a low power wake up signal for a threshold quantity of occasions, the UE 115-a may begin skipping monitoring for low power wake up signals, which may further reduce power consumption. For example, if the UE 115-a does not detect a low power wake up signal for 100 consecutive DRX cycles, the UE 115-a may start to skip monitoring for low power wake up signals. In some examples, the skipping pattern based on not detecting low power wake up signals may be configured by the network entity 105-a or preconfigured at the UE 115-a. In some examples, the skipping pattern may be modified to skip a larger quantity monitoring occasions if the UE 115-a continues to not detect a low power wake up signal. The amount of skipping may be gradually increased as more idle time is detected or elapses. For example, the UE 115-a may begin by skipping every other monitoring occasion, and if the UE 115-a does not detect a low power wake up signal within another threshold quantity of DRX cycles, the UE 115-a may begin monitoring for a low power wake up signal every fourth DRX cycle. In some examples, the UE 115-a may adjust the skipping pattern based on other factors, such as time of day. For example, the UE 115-a may skip more aggressively (e.g., skipping monitoring during a larger percentage of DRX cycles) at night, when traffic may be expected to be low.

Skipping monitoring a low power wake up signal may refer to skipping monitoring for a low power wake up signal in a DRX cycle. The DRX cycle may be a connected DRX cycle of a connected DRX mode or an idle DRX cycle of an idle mode. In some examples, skipping a low power wake up signal monitoring occasion may correspond to skipping monitoring for a low power wake up signal in a DRX cycle.

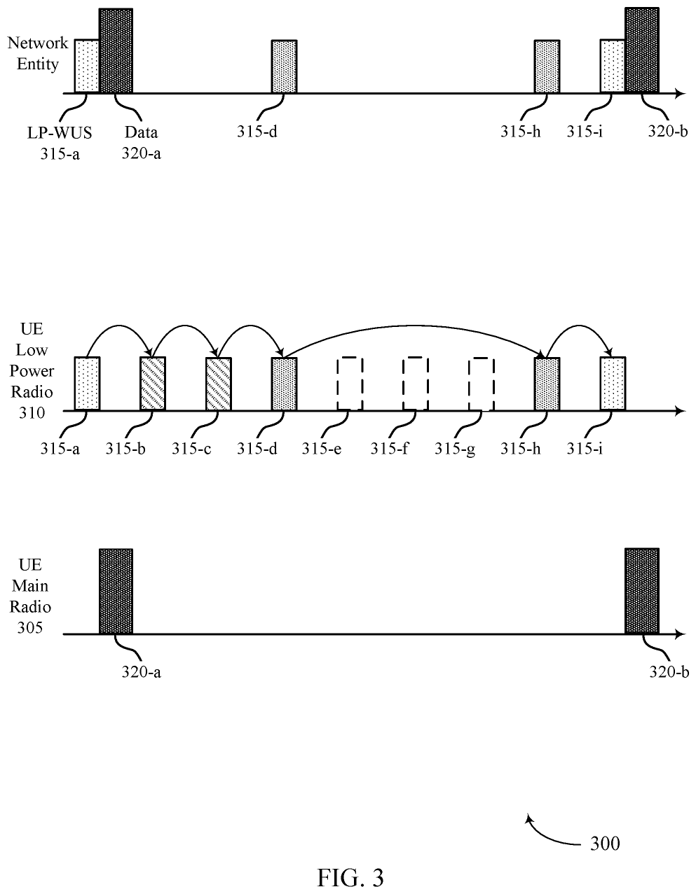

FIG. 3 shows an example of a skipping indication 300 that supports low power wake up signal skipping in accordance with one or more aspects of the present disclosure.

A network entity 105 may transmit a low power wake up signal in an occasion 315-a (e.g., a low power wake up signal occasion) to a UE 115 which indicates for the UE 115 to wake up a main radio 305 of the UE 115. The UE 115 may receive the low power wake up signal during the occasion 315-a using a low power radio 310. The UE 115 may wake up the main radio 305 based on receiving the low power wake up signal in the occasion 315-a. For example, the low power wake up signal received during the occasion 315-a may have a payload of ‘00’, which may indicate for the UE 115 to wake up the main radio and stop skipping low power wake up signals. The network entity 105 may transmit data 320-a to the UE 115, and the UE 115 may receive the data 320-a using the main radio 305. After receiving the data 320-a using the main radio 305, the UE 115 may enter a lower power state and turn off the main radio 305 or reduce power to the main radio 305.

The UE 115 may continue to monitor for low power wake up signals in following DRX cycles. For example, the UE 115 may monitor for a low power wake up signal during an occasion 315-b and an occasion 315-c. However, there may not be traffic for the UE 115, and the UE 115 may not receive or detect a low power wake up signal during these two occasions 315.

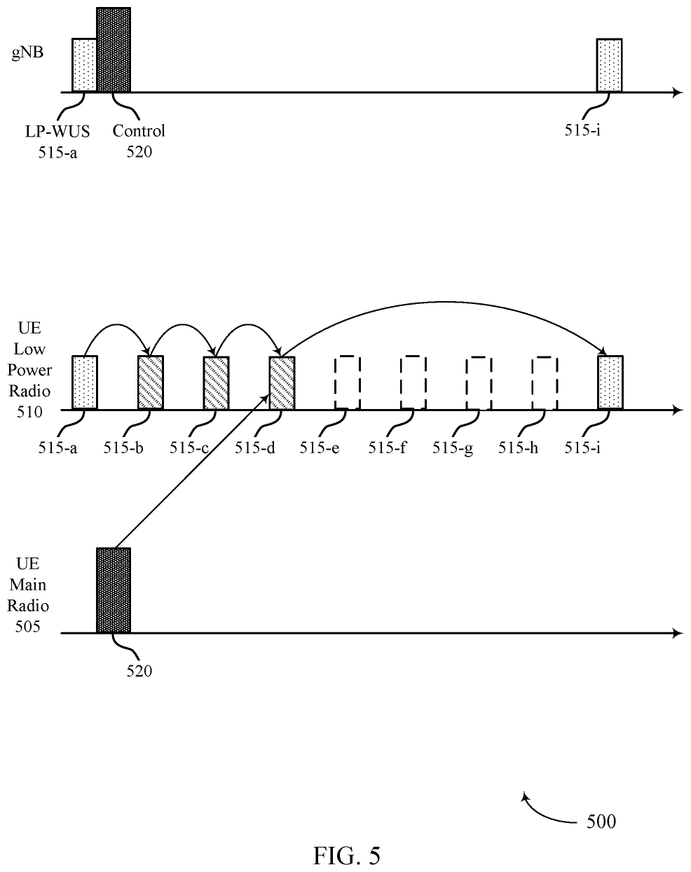

A network entity 105 may transmit a signal to a UE 115 which indicates for the UE 115 to skip use of the low power radio 310 to monitor for low power wake up signals. In the example of the skipping indication 300, the signal may be a low power wake up signal. The low power wake up signal may include or be indicative of information, which may be referred to as a payload. The payload may include a UE identifier, a UE-group identifier, information associated with a skipping configuration (e.g., a type of skipping, a skipping duration, or a skipping pattern), a cell identifier, a tracking area identifier, or any combination thereof. The payload may be carried or indicated via on/off keying, a selection of sequence for the low power wake up signal, index modulation, or modulated bits, or any combination thereof. In some other examples, such as the skipping indication 500 described with reference to FIG. 5, the signal may be downlink control signaling (e.g., downlink control information) or a MAC CE.

The network entity 105 may transmit a low power wake up signal during an occasion 315-d which indicates for the UE 115 to skip use of the low power radio 310 to monitor for one or more low power wake up signals. The wake up signal in the occasion 315-d may be indicative of a payload of ‘11’, indicating for the UE 115 to not wake up the main radio 305 and begin monitoring according to a first skipping pattern. For example, the low power wake up signal received in the occasion 315-d may indicate for the UE 115 to monitor every fourth DRX cycle, skipping a monitoring of low power wake up signals in DRX cycles between every fourth DRX cycles. The UE 115 may not monitor for low power wake up signals during an occasion 315-e, an occasion 315-f, or an occasion 315-g based on the low power wake up signal received in the occasion 315-d.

The UE 115 may monitor for a low power wake up signal in an occasion 315-h according to the skipping pattern. The network entity 105 may determine that there is pending data for the UE 115, and the network entity 105 may transmit a low power wake up signal in the occasion 315-h which configures the UE 115 to update the skipping pattern or periodicity. The low power wake up signal in the occasion 315-h may, for example, have a payload of ‘01’, indicating for the UE 115 to not wake up the main radio but monitor according to a second skipping pattern. For example, the low power wake up signal in the occasion 315-h may indicate for the UE 115 to resume monitoring for low power wake up signals or to monitor for a low power wakeup signal in every DRX cycle. The UE 115 may monitor for a low power wake up signal in an occasion 315-i of the next DRX cycle. In some examples, the network entity 105 may have pending data for the UE 115 and may transmit a wake up signal to the UE 115 in the occasion 315-i. The UE 115 may power the main radio 305 based on receiving the low power wake up signal in the occasion 315-i and receive data 320-b from the network entity using the main radio 305.

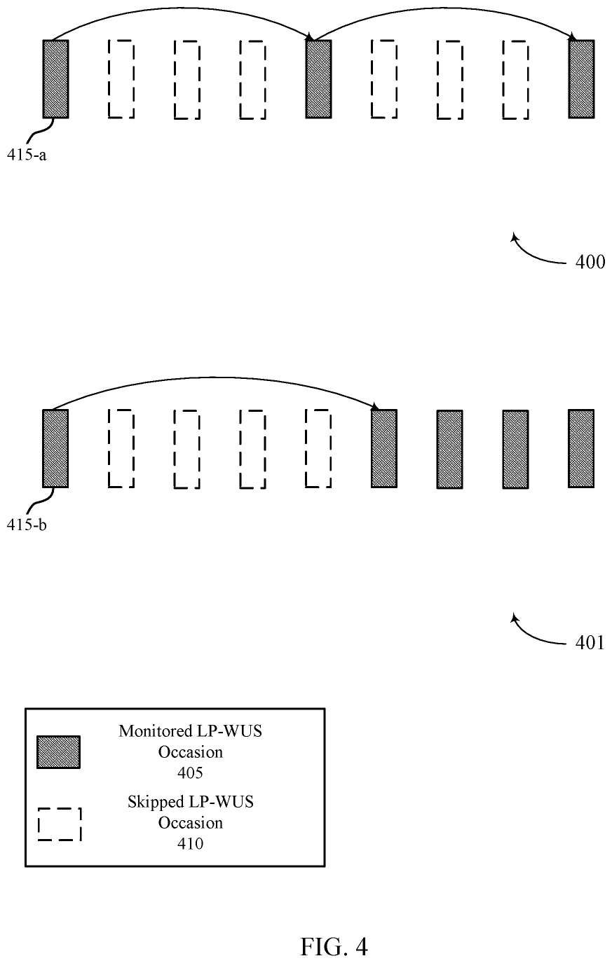

FIG. 4 shows examples of a skipping pattern 400 and a skipping pattern 401 that support low power wake up signal skipping in accordance with one or more aspects of the present disclosure.

A UE 115 may be configured to skip monitoring for low power wake up signals or skip the use of a low power radio to monitor for low power wake up signals. For example, a network entity 105 may transmit a signal 415 which indicates a monitoring pattern or skipping pattern for low power wake up signals to the UE 115.

In the skipping pattern 400, the network entity 105 may transmit a signal 415-a which indicates a first skipping pattern to the UE 115. For example, the signal 415-a may indicate for the UE 115 to monitor for a low power wake up signal every fourth DRX cycle. In the example of the skipping pattern 400, every fourth DRX cycle may correspond to a monitored low power wake up signal occasion 405. The three DRX cycles between the monitored low power wake up signal occasions 405 may correspond to skipped low power wake up signal occasions 410. The skipping pattern 400 may be an example of a pattern-based skipping technique. The UE 115 may be configured with other skipping patterns as well, such as monitoring for multiple consecutive DRX cycles then skipping multiple consecutive DRX cycles.

In the skipping pattern 401, the network entity 105 may transmit a signal 415-b which indicates for the UE 115 to skip monitoring for a low power wake up signal a next NDRX cycles. For example, the signal may indicate for the UE 115 to skip monitoring for a low power wake up signal in a next four DRX cycles. Low power wake up signal occasions in the four DRX cycles after receiving the signal 415-b may correspond to skipped low power wake up signal occasions 410. After the four skipped occasions, the UE 115 may continue monitoring for low power wake up signals (e.g., in monitored low power wake up signal occasions 405). The skipping pattern 401 may be an example of a one-time skipping or a one-time skipping pattern. In some examples, the signal 415-b may indicate a duration of time or a quantity of DRX cycles.

In some examples, the signal 415 may indicate start time for the skipping, such as by indicating a low power wake up signal occasion where the UE 115 is to begin the skipping. For example, the signal 415 may indicate for the UE 115 to begin skipping monitoring for low power wake up signal occasions after two DRX cycles.

FIG. 5 shows an example of a skipping indication 500 that supports low power wake up signal skipping in accordance with one or more aspects of the present disclosure.

A network entity 105 may transmit a low power wake up signal in an occasion 515-a (e.g., a low power wake up signal occasion) to a UE 115. The low power wake up signal may indicate for the UE 115 to wake up a main radio 505 of the UE 115. The UE 115 may receive the low power wake up signal during the occasion 515-a using a low power radio 510. The UE 115 may wake up the main radio 505 based on receiving the low power wake up signal in the occasion 515-a and monitor for control signaling or data signaling, or both, from the network entity.

For example, the network entity may transmit control signaling 520 to the UE 115. The control signaling 520 may be an example of a signal which indicates for the UE 115 to skip use of the low power radio 510 to monitor for low power wake up signals. For example, there may be little or no traffic for the UE 115, and the network entity 105 may indicate for the UE 115 to skip monitoring for low power wake up signals, which may reduce energy consumption at the UE 115.

The control signaling 520 may include or indicate information associated with skipping the monitoring of low power wake up signals. For example, the control signaling 520 may indicate a UE identifier, a UE-group identifier, information associated with a skipping configuration (e.g., a type of skipping, a skipping duration, or a skipping pattern), a cell identifier, a tracking area identifier, or any combination thereof.

In some examples, the control signaling 520 may indicate a start time for the skipping. For example, the control signaling 520 may indicate that the UE 115 is to begin skipping monitoring for low power wake up signals after an indicated period of time, DRX cycle, or low power wake up signal occasion. For example, the control signaling 520 may indicate an occasion 515-d. In some other examples, the UE 115 may start to skip monitoring occasions 515 in a DRX cycle after receiving the control signaling 520.

The UE 115 may monitor for low power wake up signals in an occasion 515-b and an occasion 515-c, but the UE 115 may not detect a low power wake up signal in the occasions 515. The UE 115 may monitor for a low power wake up signal in the occasion 515-d. In some examples, the UE 115 may not receive a low power wake up signal in the occasion 515-d, and the UE 115 may begin skipping the use of the low power radio 510 to monitor for low power wake up signals. For example, the UE 115 may begin to skip monitoring for low power wake up signals according to the skipping configuration (e.g., skipping pattern or skipping duration) indicated by the control signaling 520.

In some examples, the UE 115 may begin to skip monitoring for low power wake up signals based on not receiving a low power wake up signal before an indicated occasion 515. For example, if the UE 115 were to receive a low power wake up signal in the occasion 515-b or the occasion 515-c, the UE 115 may not skip monitoring for low power wake up signals after the occasion 515-d.

In some examples, the network entity 105 may transmit a low power wake up signal in the occasion 515-d. The low power wake up signal may indicate not to wake up the main radio 505 and to skip monitoring for low power wake up signals. For example, a sequence or modulation of a low power wake up signal transmitted during the occasion 515-d may indicate not to turn on the main radio 505 and to start skipping monitoring based on the skipping configuration indicated by the control signaling 520. In some examples, a low power wake up signal transmitted in the occasion 515-d may be indicative of information (e.g., a payload), such as an updated or modified skipping pattern or duration. For example, the control signaling 520 may indicate a first portion of a skipping configuration, and the wake up signal received in the occasion 515-d may indicate a second portion of the skipping configuration.

The UE 115 may begin skipping monitoring for low power wake up signals after the occasion 515-d. In some examples, the control signaling 520 may indicate for the UE 115 to skip monitoring for a low power wake up signal in four consecutive DRX cycles. For example, the UE 115 may not monitor for a low power wake up signals in DRX cycles corresponding to an occasion 515-e, an occasion 515-f, an occasion 515-g, or an occasion 515-h. After the skipping monitoring for the indicated quantity of DRX cycles, the UE 115 may begin monitoring again.

For example, the UE 115 may monitor for a low power wake up signal in a DRX cycle corresponding to an occasion 515-i. In some examples, the network entity 105 may have obtained pending data or control signaling for the UE 115 while the UE 115 was not monitoring for low power wake up signals. The network entity 105 may transmit a low power wake up signal in the occasion 515-i, which may indicate for the UE 115 to wake up the main radio. In some other examples, the network entity 105 may transmit a low power wake up signal in the occasion 515-i which indicates for the UE 115 to continue to skip monitoring for low power wake up signals.

In some examples, the network entity 105 may not transmit a low power wake up signal in the occasion 515-i. The UE 115 may continue to monitor for low power wake up signals in following occasions, such as if the control signaling 520 indicates a one-time skipping duration of four DRX cycles. In some other examples, the UE 115 may continue to skip monitoring for low power wake up signals, such as if the control signaling indicates a skipping pattern instead of a one-time skipping duration. In some other examples, the UE 115 may continue to skip monitoring for low power wake up signals based on not receiving a low power wake up signal in the occasion 515-i. For example, the UE 115 may have detected that the UE 115 has not received a low power wake up signal for a threshold quantity of occasions 515, and the UE 115 may continue skipping monitoring occasions after the occasion 515-i.

FIG. 6 shows examples of a skipping configuration 600, a skipping configuration 601, and a skipping configuration 602 that support low power wake up signal skipping in accordance with one or more aspects of the present disclosure.

A UE 115 may be configured to skip monitoring for low power wake up signals or skip the use of a low power radio to monitor for low power wake up signals. For example, a network entity 105 may transmit a signal to the UE 115 which is indicative that the UE is to skip use of a low power radio to monitor for low power wake up signals. In some examples, the signal may be a low power wake up signal. The low power wake up signal may convey or carry information, or a payload, such as a skipping configuration (e.g., a skipping pattern or a skipping duration), a UE identifier, a UE group identifier, a cell identifier, a tracking area identifier or any combination thereof.

The payload of a low power wake up signal may be conveyed or carried through on/off keying, sequence selection, index modulation, or modulated bits. For example, the skipping configurations 600, the skipping configuration 601, and the skipping configuration 602 may each show an example of using on/off keying to indicate a payload of a low power wake up signal. For example, a single bit may be conveyed by either using or not using a resource to transmit the low power wake up signal. Using a resource may indicate a ‘1’ bit, while not using a resource may indicate a ‘0’ bit. For example, a used resource 605, where the low power wake up signal is transmitted, may indicate a ‘1’, while an unused resource 610, where the low power wake up signal is not transmitted, may indicate a ‘0’. For example, a ‘1’ may correspond to transmission of non-zero samples on a set of frequencies, while a ‘0’ may correspond to keeping the set of frequencies off, or non-transmission.

The skipping configuration 600 may show an example of on/off keying using frequency division multiplexed resources. The used resources 605 of the skipping configuration 600 may correspond to the second resource, the fourth resource, and the seventh resource, while the unused resources 610 of the skipping configuration 600 may correspond to the zeroth resource, the first resource, the third resource, the fifth resource, and the sixth resource. This may correspond to a bit sequence of [0, 0, 1, 0, 1, 0, 0, 1], conveying eight bits of information.

The skipping configuration 601 may show an example of on/off keying using time division multiplexed resources. The used resources 605 of the skipping configuration 600 may correspond to the first resource, the fourth resource, and the seventh resource, while the unused resources 610 of the skipping configuration 600 may correspond to the zeroth resource, the second resource, the third resource, the fifth resource, and the sixth resource. This may correspond to a bit sequence of [0, 1, 0, 0, 1, 0, 0, 1], conveying eight bits of information.

The skipping configuration 602 may show an example of on/off keying using frequency division multiplexed resources and time division multiplexed resources. The used resources 605 of the skipping configuration 600 may correspond to the third resource, the fourth resource, and the seventh resource, while the unused resources 610 of the skipping configuration 600 may correspond to the zeroth resource, the first resource, the second resource, the fifth resource, and the sixth resource. This may correspond to a bit sequence of [0, 0, 0, 1, 1, 0, 0, 1], conveying eight bits of information.

In some examples, the UE 115 may be configured with multiple bit sequences and multiple skipping configurations. For example, a network entity 105 may transmit control signaling to a UE 115 indicating a mapping between bit sequences of a payload and skipping configurations. For example, the bit sequence indicated by the skipping configuration 600 may correspond to a first skipping configuration. The first skipping configuration may, for example, indicate for the UE 115 to skip use of a low power wake up radio to monitor for low power wake up signals according to a first skipping pattern. In some examples, a skipping configuration may include whether the UE 115 is to turn on the main radio (e.g., to receive control signaling or data signaling) or not turn on the main radio.

Similar techniques may be implemented for on/off keying using antenna elements or antenna ports. For example, N resources may be used to send N bits. The UE 115 may detect a bit pattern indicated by on/off keying using an energy detector.

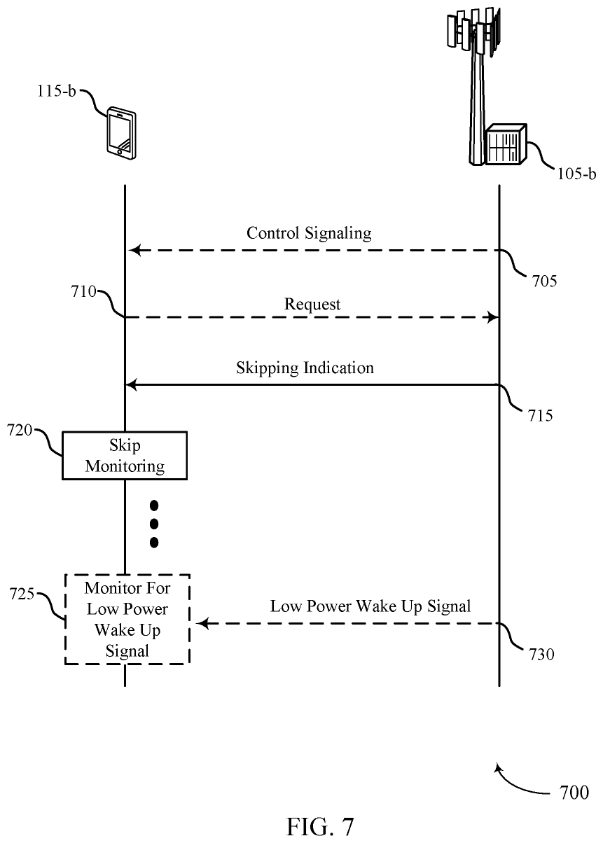

FIG. 7 shows an example of a process flow 700 that supports low power wake up signal skipping in accordance with one or more aspects of the present disclosure. The process flow 700 may be implemented by a UE 115-b or a network entity 105-b, or both. The UE 115-b and the network entity 105-b may be respective examples of a UE 115 and a network entity 105 as described with reference to FIGS. 1 and 2. In some examples, some signaling or processes of the process flow 700 may occur in a different order than presented. In some examples, some signaling or processes shown may not occur, or some signaling or processes not shown may occur, or both.

At 715, the network entity 105-b may transmit a skipping indication to the UE 115-b. The skipping indication may indicate a skipping configuration for the UE 115-b to skip the use of a low power radio to monitor for low power wake up signals. For example, the UE 115-b may receive, via a low power radio of the UE 115-b or a main radio of the UE 115-b, a signal indicative that the UE is to skip use of the low power radio to monitor one or more low power wake up signals. The signal may indicate or be indicative of a pattern for skipping monitoring of the one or more low power wake up signals, a duration for skipping monitoring of the one or more low power wake up signals, or one or more low power wake up signal monitoring occasions, or any combination thereof.

In some examples, the signal may be a low power wake up signal. For example, the UE 115-b may receive, via the low power radio of the UE 115-b, a low power wake up signal indicative that the UE is to skip use of the low power radio to monitor the one or more low power wake up signals. In some examples, the low power wake up signal may be indicative of, indicate, or include a payload, where the payload indicates a skipping configuration. For example, the payload may indicate a skipping pattern or skipping duration. In some examples, the payload may indicate whether the UE 115-b is to wake up the main radio of the UE 115-b or not.

In some examples, the payload of the low power wake up signal may be indicated via index modulation or on/off keying. For example, the low power wake up signal may be received via one or more resources, and one or more indexes of the one or more resources may indicate to skip use of the low power radio to monitor the one or more low power wake up signals. In some examples, a single bit may be conveyed by either using a resource or not using a resource. In some examples, information may be embedded in the selection of resources used for communication (e.g., a selection of time resources, frequency resources, spatial resources, antenna, or antenna ports).

In some examples, the payload of the low power wake up signal may be indicated via modulated bits. For example, the low power wake up signal may include one or more modulated bits indicative that the UE 115-b is to skip use of the low power radio to monitor the one or more low power wake up signals. For example, instead of being a known complex sequence or a known on/off-keying sequence, the low power wake up signal may be arbitrary modulated bits from a known constellation, such as a QAM constellation. In some examples, the UE 115-b may receive training bits or samples from the network entity 105-b to estimate the channel before demodulating the low power wake up signal or the bits in the low power wake up signal. The training samples may be transmitted with the low power wake up signal or separately.

In some examples, the payload of the low power wake up signal may be indicated via sequence selection. For example, the low power wake up signal may include a sequence, and a sequence index of the sequence may indicate to skip use of the low power radio to monitor the one or more low power wake up signals.

In some examples, the network entity 105-b may transmit control signaling to the UE 115-b at 705. In some examples, the control signaling may indicate one or more skipping configurations or bit sequences, or a mapping between skipping configurations and bit sequences. In some examples, the control signaling may indicate resources (e.g., for conveying a payload via on/off keying or index modulation), one or more sequences or sequence indexes (e.g., for conveying a payload via sequence selection), one or more training signals, reference signals, bits or sequences (e.g., for conveying a payload via modulated bits), or any combination thereof.

For example, the UE 115-b may receive control signaling indicating multiple resources. The UE 115-b may monitor for the low power wake up signal via the multiple resources. The UE 115-b may determine the payload of the low power wake up signal based on the resources used to transmit the low power wakeup signal.

Additionally, or alternatively, the UE 115-b may receive control signaling indicating one or more sequence indexes. The low power wake up signal may include a sequence having a sequence index from the one or more sequence indexes, and the UE 115-b may determine the payload of the low power wake up signal based on the sequence index corresponding to the sequence of the low power wake up signal.

In some examples, the signal may be control signaling. For example, the UE 115-b may receive, via the main radio of the UE 115-b, a control signal indicative that the UE 115-b is to skip use of the low power radio to monitor the one or more low power wake up signals. The control signal may indicate a skipping configuration, such as a skipping pattern or skipping duration. In some examples, the control signal may indicate a start time for the skipping configuration. For example, the control signal may indicate a DRX cycle or low power wake up signal monitoring occasion where the UE 115-b is to start skipping the monitoring. Downlink control information or a MAC CE may be examples of the control signaling.

In some examples, at 710, the UE 115-b may transmit a request for the signal indicative that the UE is to skip use of the low power radio to monitor the one or more low power wake up signals. For example, the UE 115-b may transmit the request based on a battery state of the UE 115-b, traffic conditions at the UE 115-b, an expected battery condition of the UE 115-b, or expected traffic conditions of the UE 115-b, or any combination thereof. In some examples, the network entity 105-b may transmit the signal based on the request.

At 720, the UE 115-b may skip monitoring of the one or more low power wake up signals based on the signal. For example, the UE 115-b may skip according to a skipping pattern or a skipping duration indicated by the signal. For example, the signal may indicate to skip monitoring for low power wake up signals in every other DRX cycle (e.g., a pattern-based skipping configuration). The UE 115-b may monitor for a low power wake up signal in a low power wake up signal monitoring occasion in every other DRX cycle (e.g., and skip or not monitor for a low power wake up signal in the wake up signal monitoring occasions of the other DRX cycles). In some examples, the signal may indicate to skip a quantity of DRX cycles (e.g., a one-time skipping configuration). For example, the signal may indicate to skip monitoring in a next four DRX cycles. The UE 115-b may skip monitoring for low power wake up signals in low power wake up signal monitoring occasions of the next four DRX cycles.

In some examples, the UE 115-b may resume monitoring for low power wake up signals. For example, after a one-time skipping configuration, the UE 115-b may resume monitoring for low power wake up signals at 725.

In some examples, the network entity 105-b may transmit a low power wake up signal at 730. In some examples, the low power wake up signal may update a skipping configuration at the UE 115-b. For example, the low power wake up signal may be indicative of another skipping pattern or skipping duration. In some examples, the low power wake up signal may indicate the UE 115-b is to stop skipping monitoring for low power wake up signals. The low power wake up signal received at 730 may or may not wake up the main radio of the UE 115-b.

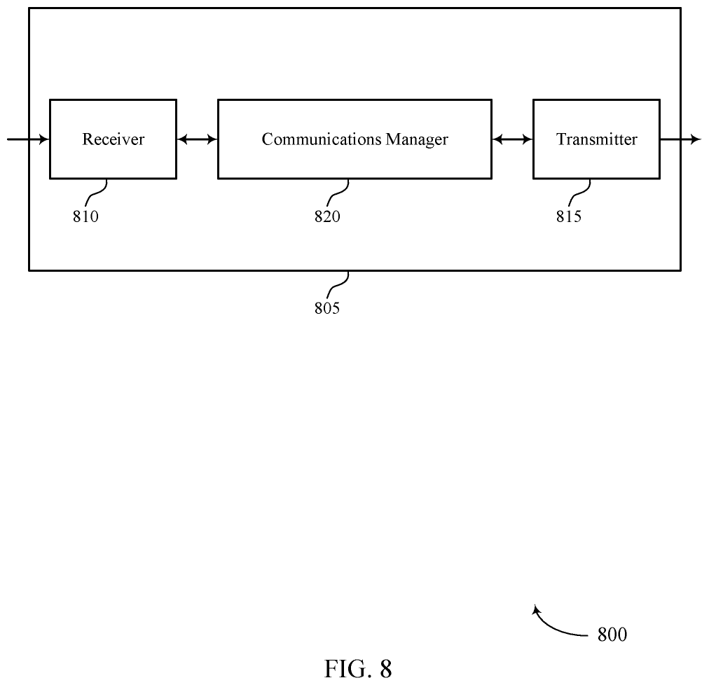

FIG. 8 shows a block diagram 800 of a device 805 that supports low power wake up signal skipping in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to low power wake up signal skipping). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to low power wake up signal skipping). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of low power wake up signal skipping as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving, via a low power radio of the UE or a main radio of the UE, a signal indicative that the UE is to skip use of the low power radio to monitor one or more low power wake up signals. The communications manager 820 is capable of, configured to, or operable to support a means for skipping monitoring of the one or more low power wake up signals based on the signal.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption, such as by reducing monitoring at the device 805.

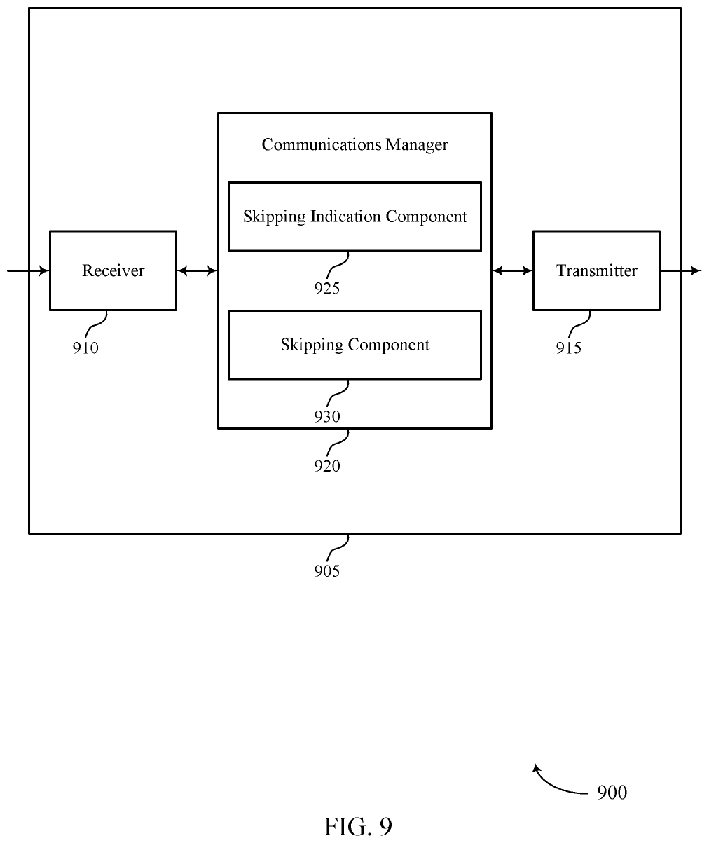

FIG. 9 shows a block diagram 900 of a device 905 that supports low power wake up signal skipping in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to low power wake up signal skipping). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to low power wake up signal skipping). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of low power wake up signal skipping as described herein. For example, the communications manager 920 may include a skipping indication component 925 a skipping component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The skipping indication component 925 is capable of, configured to, or operable to support a means for receiving, via a low power radio of the UE or a main radio of the UE, a signal indicative that the UE is to skip use of the low power radio to monitor one or more low power wake up signals. The skipping component 930 is capable of, configured to, or operable to support a means for skipping monitoring of the one or more low power wake up signals based on the signal.

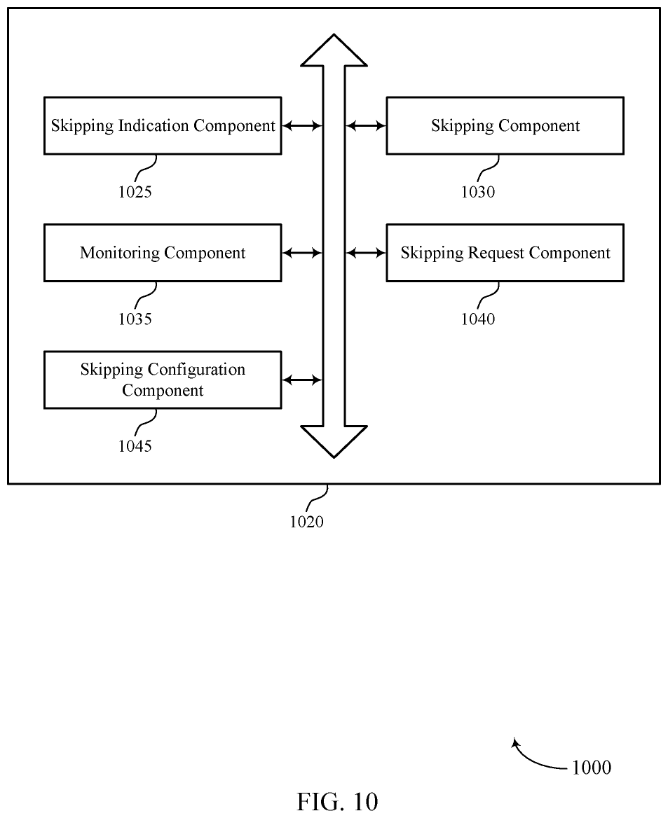

FIG. 10 shows a block diagram 1000 of a communications manager 1020 that supports low power wake up signal skipping in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of low power wake up signal skipping as described herein. For example, the communications manager 1020 may include a skipping indication component 1025, a skipping component 1030, a monitoring component 1035, a skipping request component 1040, a skipping configuration component 1045, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The skipping indication component 1025 is capable of, configured to, or operable to support a means for receiving, via a low power radio of the UE or a main radio of the UE, a signal indicative that the UE is to skip use of the low power radio to monitor one or more low power wake up signals. The skipping component 1030 is capable of, configured to, or operable to support a means for skipping monitoring of the one or more low power wake up signals based on the signal.

In some examples, to support receiving the signal, the skipping indication component 1025 is capable of, configured to, or operable to support a means for receiving, via the low power radio of the UE, a low power wake up signal indicative that the UE is to skip use of the low power radio to monitor the one or more low power wake up signals.

In some examples, the low power wake up signal is received via one or more resources. In some examples, one or more indexes of the one or more resources indicate to skip use of the low power radio to monitor the one or more low power wake up signals.

In some examples, the one or more resources correspond to time resources, frequency resources, spatial resources, or any combination thereof.

In some examples, the skipping configuration component 1045 is capable of, configured to, or operable to support a means for receiving control signaling indicating a set of multiple resources including the one or more resources. In some examples, the skipping configuration component 1045 is capable of, configured to, or operable to support a means for monitoring for the low power wake up signal via the set of multiple resources based on the control signaling.

In some examples, the low power wake up signal includes one or more modulated bits indicative that the UE is to skip use of the low power radio to monitor the one or more low power wake up signals.

In some examples, the skipping indication component 1025 is capable of, configured to, or operable to support a means for detecting the low power wake up signal using an envelope detector.

In some examples, the low power wake up signal includes a sequence. In some examples, a sequence index of the sequence indicates to skip use of the low power radio to monitor the one or more low power wake up signals.

In some examples, the skipping configuration component 1045 is capable of, configured to, or operable to support a means for receiving control signaling indicating one or more sequence indexes including at least the sequence index and one or more corresponding sets of wake up signal skipping parameters.

In some examples, the low power wake up signal indicates an identifier of the UE, a group identifier corresponding to a set of multiple UEs, a cell identifier, a tracking area identifier, or any combination thereof.

In some examples, to support receiving the signal, the skipping indication component 1025 is capable of, configured to, or operable to support a means for receiving, via the main radio of the UE, a control signal indicative that the UE is to skip use of the low power radio to monitor the one or more low power wake up signals.

In some examples, the skipping indication component 1025 is capable of, configured to, or operable to support a means for receiving a low power wake up signal during a low power wake up signal monitoring occasion indicated by the control signal, where powering down the low power radio is based on receiving the low power wake up signal.

In some examples, the skipping component 1030 is capable of, configured to, or operable to support a means for powering down the main radio based on receiving the control signal without receiving a downlink data message associated with the control signal.

In some examples, to support skipping the monitoring, the skipping component 1030 is capable of, configured to, or operable to support a means for skipping the monitoring of the one or more low power wake up signals based on non-receipt of a threshold quantity of consecutive low power wake up signals.

In some examples, the signal indicates a pattern for skipping monitoring of the one or more low power wake up signals, a duration for skipping monitoring of the one or more low power wake up signals, or one or more low power wake up signal monitoring occasions, or any combination thereof.

In some examples, to support skipping the monitoring, the skipping component 1030 is capable of, configured to, or operable to support a means for skipping a set of multiple low power wake up signals, where the signal is indicative of a quantity of the set of multiple low power wake up signals.

In some examples, the monitoring component 1035 is capable of, configured to, or operable to support a means for receiving an indication to resume monitoring of low power wake up signals. In some examples, the monitoring component 1035 is capable of, configured to, or operable to support a means for monitoring for the low power wake up signals based on the indication to resume monitoring.

In some examples, the skipping request component 1040 is capable of, configured to, or operable to support a means for transmitting a request for the signal indicative that the UE is to skip use of the low power radio to monitor the one or more low power wake up signals, where the signal is received based on the request.

In some examples, the request is transmitted based on a battery state of the UE, traffic conditions at the UE, or both.

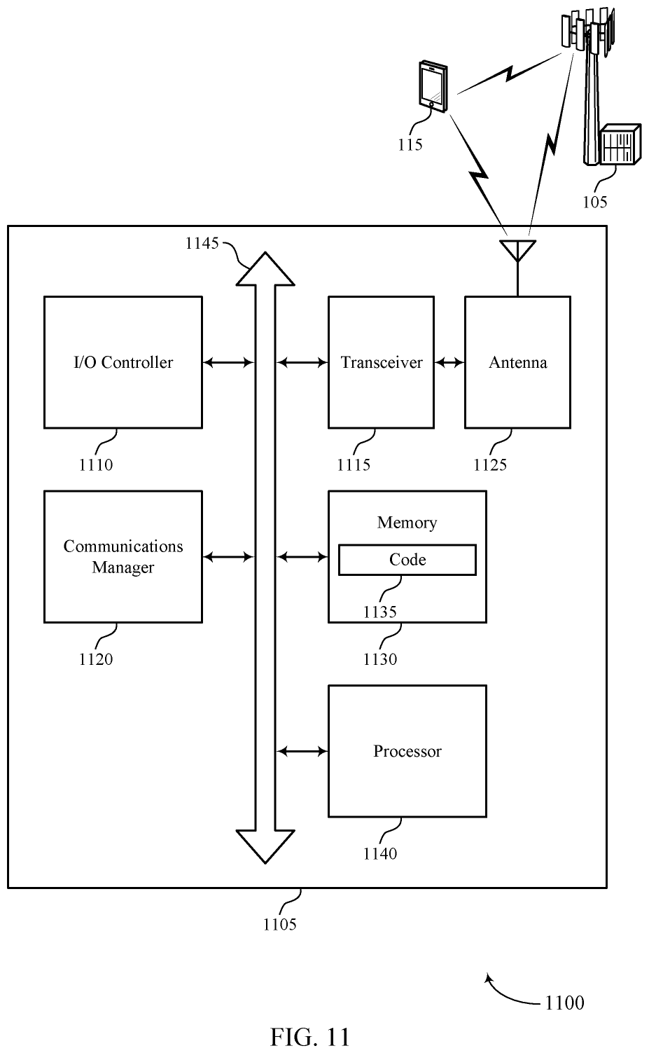

FIG. 11 shows a diagram of a system 1100 including a device 1105 that supports low power wake up signal skipping in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (1/O) controller 1110, a transceiver 1115, an antenna 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable code 1135 including instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may contain, among other things, a basic I/O system (BIOS) which may control basic hardware or software operation such as the interaction with peripheral components or devices.

The at least one processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting low power wake up signal skipping). For example, the device 1105 or a component of the device 1105 may include at least one processor 1140 and at least one memory 1130 coupled with or to the at least one processor 1140, the at least one processor 1140 and at least one memory 1130 configured to perform various functions described herein. In some examples, the at least one processor 1140 may include multiple processors and the at least one memory 1130 may include multiple memories. One or more of the multiple processors may be coupled with one or more of the multiple memories, which may, individually or collectively, be configured to perform various functions herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving, via a low power radio of the UE or a main radio of the UE, a signal indicative that the UE is to skip use of the low power radio to monitor one or more low power wake up signals. The communications manager 1120 is capable of, configured to, or operable to support a means for skipping monitoring of the one or more low power wake up signals based on the signal.

By including or configuring the communications manager 1120 in accordance with examples as described herein, the device 1105 may support techniques for reduced power consumption and longer battery life.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of low power wake up signal skipping as described herein, or the at least one processor 1140 and the at least one memory 1130 may be otherwise configured to, individually or collectively, perform or support such operations.

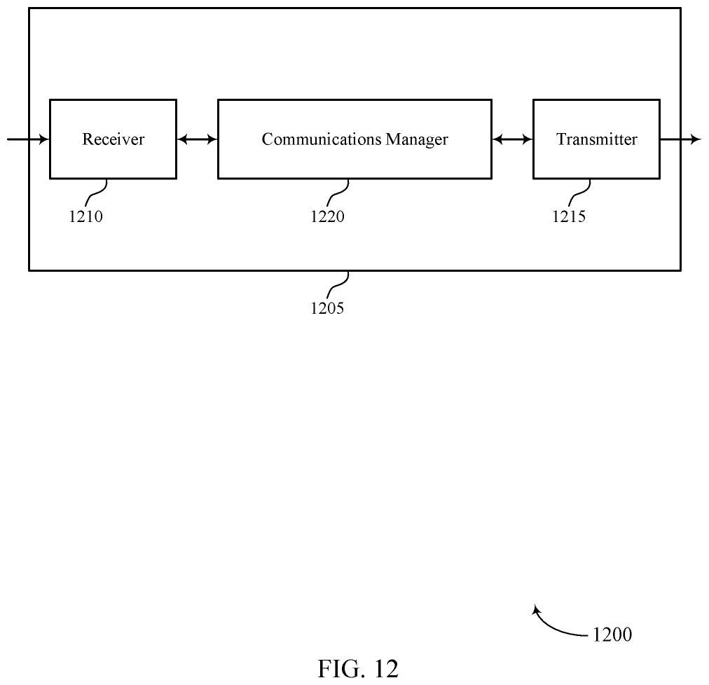

FIG. 12 shows a block diagram 1200 of a device 1205 that supports low power wake up signal skipping in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of low power wake up signal skipping as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor. If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for transmitting, to a UE equipped with a low power radio and a main radio, a signal indicative that the UE is to skip use of the low power radio to monitor one or more low power wake up signals. The communications manager 1220 is capable of, configured to, or operable to support a means for refraining from transmitting the one or more low power wake up signals to the low power radio of the UE based on transmitting the signal.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced power consumption.

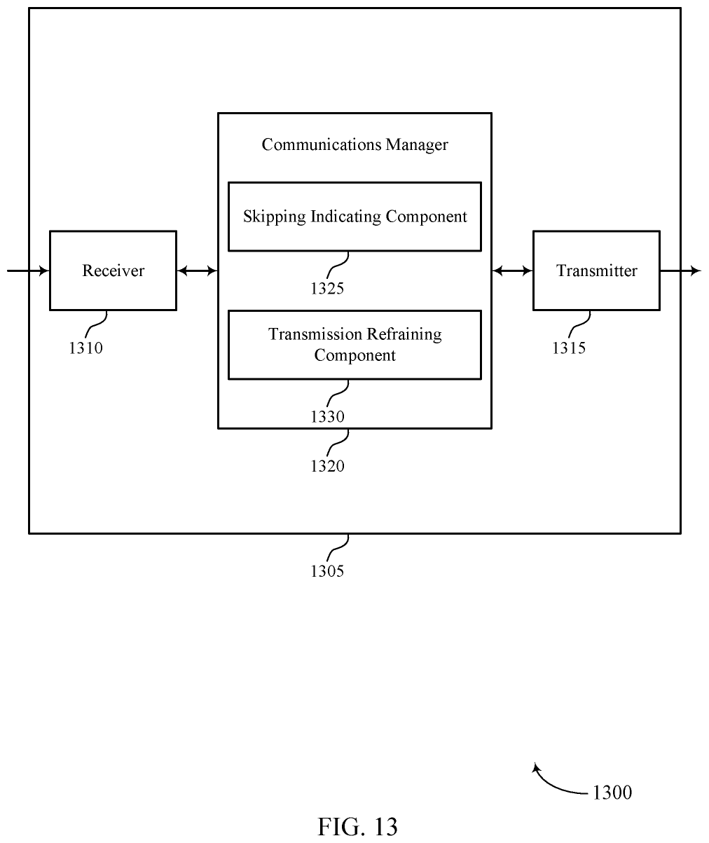

FIG. 13 shows a block diagram 1300 of a device 1305 that supports low power wake up signal skipping in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, and the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of low power wake up signal skipping as described herein. For example, the communications manager 1320 may include a skipping indicating component 1325 a transmission refraining component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The skipping indicating component 1325 is capable of, configured to, or operable to support a means for transmitting, to a UE equipped with a low power radio and a main radio, a signal indicative that the UE is to skip use of the low power radio to monitor one or more low power wake up signals. The transmission refraining component 1330 is capable of, configured to, or operable to support a means for refraining from transmitting the one or more low power wake up signals to the low power radio of the UE based on transmitting the signal.

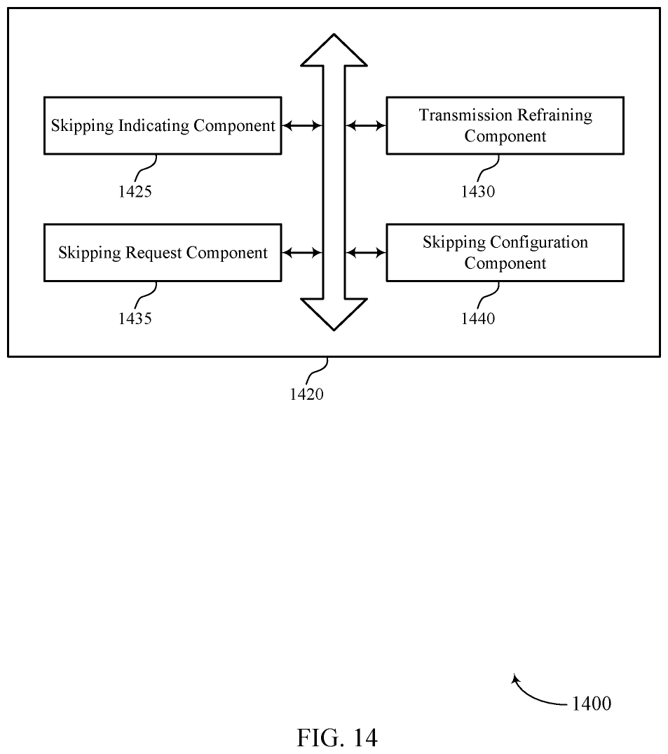

FIG. 14 shows a block diagram 1400 of a communications manager 1420 that supports low power wake up signal skipping in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of low power wake up signal skipping as described herein. For example, the communications manager 1420 may include a skipping indicating component 1425, a transmission refraining component 1430, a skipping request component 1435, a skipping configuration component 1440, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The skipping indicating component 1425 is capable of, configured to, or operable to support a means for transmitting, to a UE equipped with a low power radio and a main radio, a signal indicative that the UE is to skip use of the low power radio to monitor one or more low power wake up signals. The transmission refraining component 1430 is capable of, configured to, or operable to support a means for refraining from transmitting the one or more low power wake up signals to the low power radio of the UE based on transmitting the signal.

In some examples, to support transmitting the signal, the skipping indicating component 1425 is capable of, configured to, or operable to support a means for transmitting, to the low power radio of the UE, a low power wake up signal indicative that the UE is to skip use of the low power radio to monitor the one or more low power wake up signals.

In some examples, the low power wake up signal is transmitted via one or more resources. In some examples, one or more indexes of the one or more resources indicate to skip use of the low power radio to monitor the one or more low power wake up signals.

In some examples, the one or more resources correspond to time resources, frequency resources, spatial resources, or any combination thereof.

In some examples, the skipping configuration component 1440 is capable of, configured to, or operable to support a means for transmitting control signaling indicating a set of multiple resources including the one or more resources, where the low power wake up signal is transmitted via the one or more resources based on the control signaling.

In some examples, the low power wake up signal includes a sequence. In some examples, a sequence index of the sequence indicates to skip use of the low power radio to monitor the one or more low power wake up signals.

In some examples, the skipping configuration component 1440 is capable of, configured to, or operable to support a means for transmitting control signaling indicating one or more sequence indexes including at least the sequence index and one or more corresponding sets of wake up signal skipping parameters.

In some examples, the low power wake up signal indicates an identifier of the UE, a group identifier corresponding to a set of multiple UEs, a cell identifier, a tracking area identifier, or any combination thereof.

In some examples, to support transmitting the signal, the skipping indicating component 1425 is capable of, configured to, or operable to support a means for transmitting, to the main radio of the UE, a control signal indicative that the UE is to skip use of the low power radio to monitor the one or more low power wake up signals.

In some examples, the skipping indicating component 1425 is capable of, configured to, or operable to support a means for transmitting a low power wake up signal during a low power wake up signal monitoring occasion, where the control signal indicates the low power wake up signal monitoring occasion.

In some examples, the signal indicates a pattern for skipping monitoring of the one or more low power wake up signals, a duration for skipping monitoring of the one or more low power wake up signals, or one or more low power wake up signal monitoring occasions, or any combination thereof.

In some examples, the skipping request component 1435 is capable of, configured to, or operable to support a means for receiving a request for the signal indicative that the UE is to skip use of the low power radio to monitor the one or more low power wake up signals, where the signal is transmitted based on the request.

In some examples, the request indicates a battery state of the UE, traffic conditions at the UE, or both.

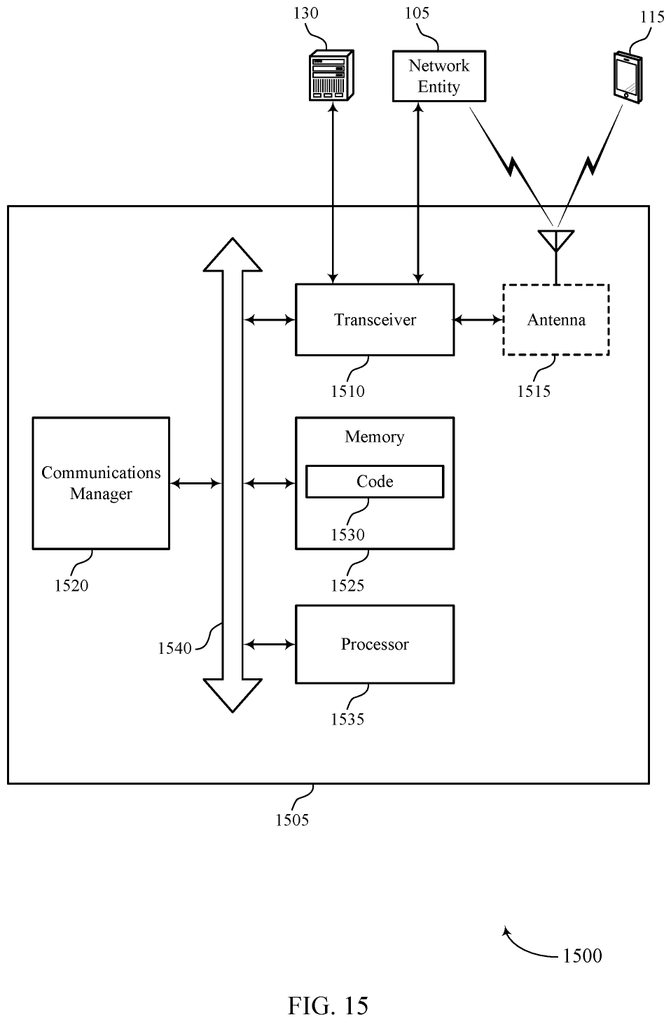

FIG. 15 shows a diagram of a system 1500 including a device 1505 that supports low power wake up signal skipping in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., a communication link 125, a backhaul communication link 120, a midhaul communication link 162, a fronthaul communication link 168).

The at least one memory 1525 may include RAM, ROM, or any combination thereof. The at least one memory 1525 may store computer-readable, computer-executable code 1530 including instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may contain, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting low power wake up signal skipping). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525). In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for transmitting, to a UE equipped with a low power radio and a main radio, a signal indicative that the UE is to skip use of the low power radio to monitor one or more low power wake up signals. The communications manager 1520 is capable of, configured to, or operable to support a means for refraining from transmitting the one or more low power wake up signals to the low power radio of the UE based on transmitting the signal.

By including or configuring the communications manager 1520 in accordance with examples as described herein, the device 1505 may support techniques for reduced power consumption.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of low power wake up signal skipping as described herein, or the at least one processor 1535 and the at least one memory 1525 may be otherwise configured to, individually or collectively, perform or support such operations.

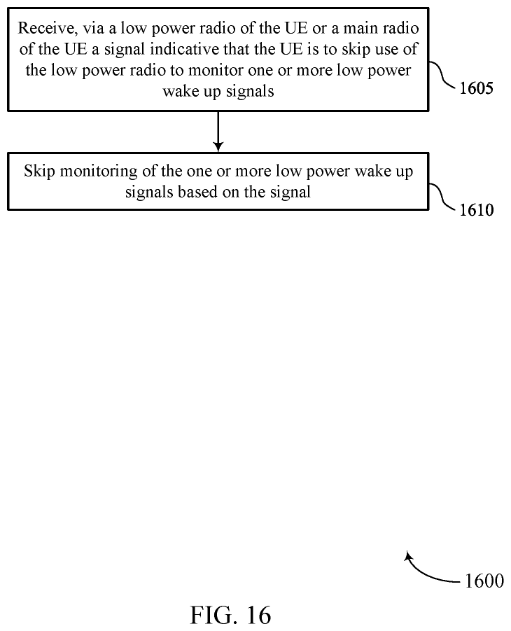

FIG. 16 shows a flowchart illustrating a method 1600 that supports low power wake up signal skipping in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, via a low power radio of the UE or a main radio of the UE, a signal indicative that the UE is to skip use of the low power radio to monitor one or more low power wake up signals. The operations of block 1605 may be performed in accordance with examples as disclosed herein. In some examples, aspects of the operations of 1605 may be performed by a skipping indication component 1025 as described with reference to FIG. 10.

At 1610, the method may include skipping monitoring of the one or more low power wake up signals based on the signal. The operations of block 1610 may be performed in accordance with examples as disclosed herein. In some examples, aspects of the operations of 1610 may be performed by a skipping component 1030 as described with reference to FIG. 10.

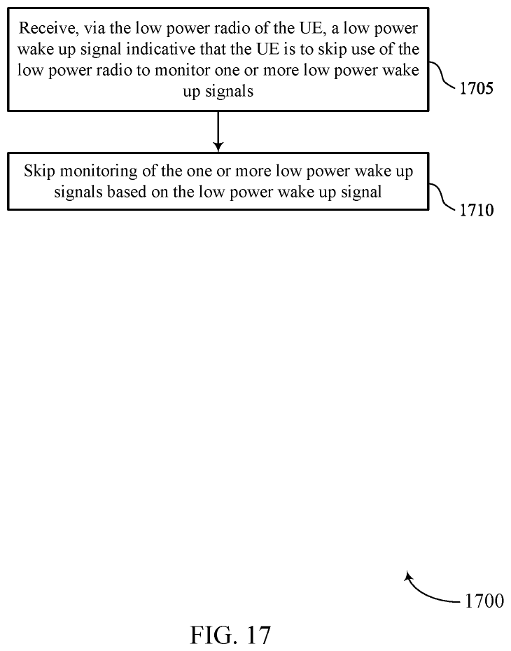

FIG. 17 shows a flowchart illustrating a method 1700 that supports low power wake up signal skipping in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving, via the low power radio of the UE, a low power wake up signal indicative that the UE is to skip use of the low power radio to monitor one or more low power wake up signals. The operations of block 1705 may be performed in accordance with examples as disclosed herein. In some examples, aspects of the operations of 1705 may be performed by a skipping indication component 1025 as described with reference to FIG. 10.

At 1710, the method may include skipping monitoring of the one or more low power wake up signals based on the low power wake up signal. The operations of block 1710 may be performed in accordance with examples as disclosed herein. In some examples, aspects of the operations of 1710 may be performed by a skipping component 1030 as described with reference to FIG. 10.

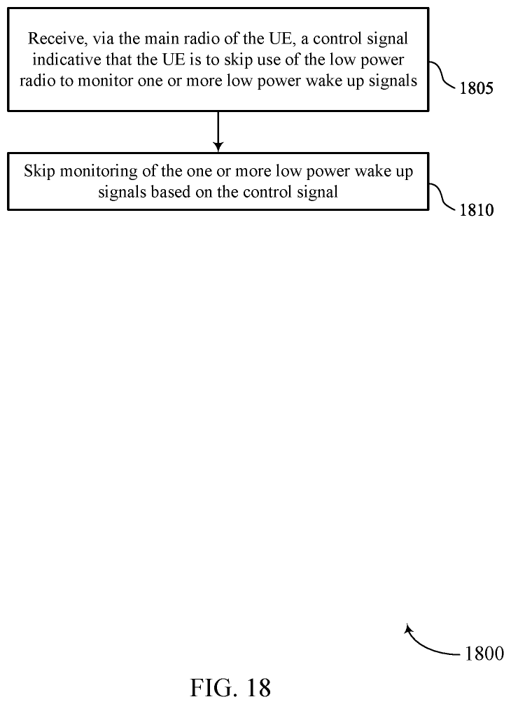

FIG. 18 shows a flowchart illustrating a method 1800 that supports low power wake up signal skipping in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include receiving, via the main radio of the UE, a control signal indicative that the UE is to skip use of the low power radio to monitor one or more low power wake up signals. The operations of block 1805 may be performed in accordance with examples as disclosed herein. In some examples, aspects of the operations of 1805 may be performed by a skipping indication component 1025 as described with reference to FIG. 10.

At 1810, the method may include skipping monitoring of the one or more low power wake up signals based on the control signal. The operations of block 1810 may be performed in accordance with examples as disclosed herein. In some examples, aspects of the operations of 1810 may be performed by a skipping component 1030 as described with reference to FIG. 10.

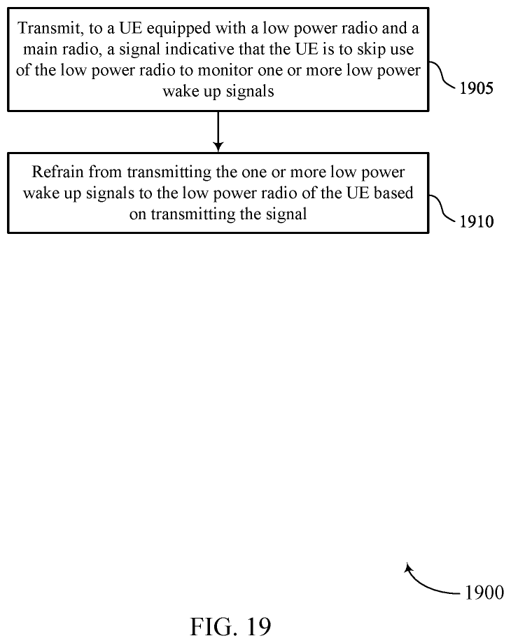

FIG. 19 shows a flowchart illustrating a method 1900 that supports low power wake up signal skipping in accordance with aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a UE equipped with a low power radio and a main radio, a signal indicative that the UE is to skip use of the low power radio to monitor one or more low power wake up signals. The operations of block 1905 may be performed in accordance with examples as disclosed herein. In some examples, aspects of the operations of 1905 may be performed by a skipping indicating component 1425 as described with reference to FIG. 14.

At 1910, the method may include refraining from transmitting the one or more low power wake up signals to the low power radio of the UE based on transmitting the signal. The operations of block 1910 may be performed in accordance with examples as disclosed herein. In some examples, aspects of the operations of 1910 may be performed by a transmission refraining component 1430 as described with reference to FIG. 14.

The following provides an overview of aspects of the present disclosure:

Aspect 1: A method for wireless communications at a UE, comprising: receiving, via a low power radio of the UE or a main radio of the UE a signal indicative that the UE is to skip use of the low power radio to monitor one or more low power wake up signals; and skipping monitoring of the one or more low power wake up signals based at least in part on the signal.

Aspect 2: The method of aspect 1, wherein receiving the signal comprises: receiving, via the low power radio of the UE, a low power wake up signal indicative that the UE is to skip use of the low power radio to monitor the one or more low power wake up signals.

Aspect 3: The method of aspect 2, wherein the low power wake up signal is received via one or more resources, one or more indexes of the one or more resources indicate to skip use of the low power radio to monitor the one or more low power wake up signals.

Aspect 4: The method of aspect 3, wherein the one or more resources correspond to time resources, frequency resources, spatial resources, or any combination thereof.

Aspect 5: The method of any of aspects 3 through 4, further comprising: receiving control signaling indicating a plurality of resources including the one or more resources; and monitoring for the low power wake up signal via the plurality of resources based at least in part on the control signaling.

Aspect 6: The method of any of aspects 2 through 5, wherein the low power wake up signal comprises one or more modulated bits indicative that the UE is to skip use of the low power radio to monitor the one or more low power wake up signals.

Aspect 7: The method of any of aspects 2 through 6, further comprising: detecting the low power wake up signal using an envelope detector.

Aspect 8: The method of any of aspects 2 through 7, wherein the low power wake up signal comprises a sequence, a sequence index of the sequence indicates to skip use of the low power radio to monitor the one or more low power wake up signals.

Aspect 9: The method of aspect 8, further comprising: receiving control signaling indicating one or more sequence indexes including at least the sequence index and one or more corresponding sets of wake up signal skipping parameters.

Aspect 10: The method of any of aspects 2 through 9, wherein the low power wake up signal indicates an identifier of the UE, a group identifier corresponding to a plurality of UEs, a cell identifier, a tracking area identifier, or any combination thereof.

Aspect 11: The method of any of aspects 1 through 10, wherein receiving the signal comprises: receiving, via the main radio of the UE, a control signal indicative that the UE is to skip use of the low power radio to monitor the one or more low power wake up signals.

Aspect 12: The method of aspect 11, further comprising: receiving a low power wake up signal during a low power wake up signal monitoring occasion indicated by the control signal, wherein powering down the low power radio is based at least in part on receiving the low power wake up signal.

Aspect 13: The method of any of aspects 11 through 12, further comprising: powering down the main radio based at least in part on receiving the control signal without receiving a downlink data message associated with the control signal.

Aspect 14: The method of any of aspects 1 through 13, wherein skipping the monitoring comprises: skipping the monitoring of the one or more low power wake up signals based at least in part on non-receipt of a threshold quantity of consecutive low power wake up signals.

Aspect 15: The method of any of aspects 1 through 14, wherein the signal indicates a pattern for skipping monitoring of the one or more low power wake up signals, a duration for skipping monitoring of the one or more low power wake up signals, or one or more low power wake up signal monitoring occasions, or any combination thereof.

Aspect 16: The method of any of aspects 1 through 15, wherein skipping the monitoring comprises: skipping a plurality of low power wake up signals, wherein the signal is indicative of a quantity of the plurality of low power wake up signals.

Aspect 17: The method of any of aspects 1 through 16, further comprising: receiving an indication to resume monitoring of low power wake up signals; and monitoring for the low power wake up signals based at least in part on the indication to resume monitoring.

Aspect 18: The method of any of aspects 1 through 17, further comprising: transmitting a request for the signal indicative that the UE is to skip use of the low power radio to monitor the one or more low power wake up signals, wherein the signal is received based at least in part on the request.

Aspect 19: The method of aspect 18, wherein the request is transmitted based at least in part on a battery state of the UE, traffic conditions at the UE, or both.

Aspect 20: A method for wireless communications at a network entity, comprising: transmitting, to a UE equipped with a low power radio and a main radio, a signal indicative that the UE is to skip use of the low power radio to monitor one or more low power wake up signals; and refraining from transmitting the one or more low power wake up signals to the low power radio of the UE based at least in part on transmitting the signal.

Aspect 21: The method of aspect 20, wherein transmitting the signal comprises: transmitting, to the low power radio of the UE, a low power wake up signal indicative that the UE is to skip use of the low power radio to monitor the one or more low power wake up signals.

Aspect 22: The method of aspect 21, wherein the low power wake up signal is transmitted via one or more resources, one or more indexes of the one or more resources indicate to skip use of the low power radio to monitor the one or more low power wake up signals.

Aspect 23: The method of aspect 22, wherein the one or more resources correspond to time resources, frequency resources, spatial resources, or any combination thereof.

Aspect 24: The method of any of aspects 22 through 23, further comprising: transmitting control signaling indicating a plurality of resources including the one or more resources, wherein the low power wake up signal is transmitted via the one or more resources based at least in part on the control signaling.

Aspect 25: The method of any of aspects 21 through 24, wherein the low power wake up signal comprises a sequence, a sequence index of the sequence indicates to skip use of the low power radio to monitor the one or more low power wake up signals.

Aspect 26: The method of aspect 25, further comprising: transmitting control signaling indicating one or more sequence indexes including at least the sequence index and one or more corresponding sets of wake up signal skipping parameters.

Aspect 27: The method of any of aspects 21 through 26, wherein the low power wake up signal indicates an identifier of the UE, a group identifier corresponding to a plurality of UEs, a cell identifier, a tracking area identifier, or any combination thereof.

Aspect 28: The method of any of aspects 20 through 27, wherein transmitting the signal comprises: transmitting, to the main radio of the UE, a control signal indicative that the UE is to skip use of the low power radio to monitor the one or more low power wake up signals.

Aspect 29: The method of aspect 28, further comprising: transmitting a low power wake up signal during a low power wake up signal monitoring occasion, wherein the control signal indicates the low power wake up signal monitoring occasion.

Aspect 30: The method of any of aspects 20 through 29, wherein the signal indicates a pattern for skipping monitoring of the one or more low power wake up signals, a duration for skipping monitoring of the one or more low power wake up signals, or one or more low power wake up signal monitoring occasions, or any combination thereof.

Aspect 31: The method of any of aspects 20 through 30, further comprising: receiving a request for the signal indicative that the UE is to skip use of the low power radio to monitor the one or more low power wake up signals, wherein the signal is transmitted based at least in part on the request.

Aspect 32: The method of aspect 31, wherein the request indicates a battery state of the UE, traffic conditions at the UE, or both.

Aspect 33: A UE for wireless communications, comprising one or more memories storing processor-executable code, and one or more processors coupled with the one or more memories and individually or collectively operable to execute the code to cause the UE to perform a method of any of aspects 1 through 19.

Aspect 34: A UE for wireless communications, comprising at least one means for performing a method of any of aspects 1 through 19.

Aspect 35: A non-transitory computer-readable medium storing code for wireless communications, the code comprising instructions executable by one or more processors to perform a method of any of aspects 1 through 19.

Aspect 36: A network entity for wireless communications, comprising one or more memories storing processor-executable code, and one or more processors coupled with the one or more memories and individually or collectively operable to execute the code to cause the network entity to perform a method of any of aspects 20 through 32.

Aspect 37: A network entity for wireless communications, comprising at least one means for performing a method of any of aspects 20 through 32.

Aspect 38: A non-transitory computer-readable medium storing code for wireless communications, the code comprising instructions executable by one or more processors to perform a method of any of aspects 20 through 32.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a low power radio of the UE or a main radio of the UE, a signal indicative that the UE is to skip use of the low power radio to monitor one or more low power wake up signals; and
skip monitoring of the one or more low power wake up signals based at least in part on the signal.

2. The UE of claim 1, wherein, to receive the signal, the one or more processors are individually or collectively operable to execute the code to cause the UE to:
receive, via the low power radio of the UE, a low power wake up signal indicative that the UE is to skip use of the low power radio to monitor the one or more low power wake up signals.

3. The UE of claim 2, wherein the low power wake up signal is received via one or more resources, and one or more indexes of the one or more resources indicate to skip use of the low power radio to monitor the one or more low power wake up signals.

4. The UE of claim 3, wherein the one or more resources correspond to time resources, frequency resources, spatial resources, or any combination thereof.

5. The UE of claim 3, wherein the one or more processors are individually or collectively further operable to execute the code to cause the UE to:
receive control signaling indicating a plurality of resources including the one or more resources; and
monitor for the low power wake up signal via the plurality of resources based at least in part on the control signaling.

6. The UE of claim 2, wherein the low power wake up signal comprises one or more modulated bits indicative that the UE is to skip use of the low power radio to monitor the one or more low power wake up signals.

7. The UE of claim 2, wherein the one or more processors are individually or collectively further operable to execute the code to cause the UE to:
detect the low power wake up signal using an envelope detector.

8. The UE of claim 2, wherein the low power wake up signal comprises a sequence, and a sequence index of the sequence indicates to skip use of the low power radio to monitor the one or more low power wake up signals.

9. The UE of claim 8, wherein the one or more processors are individually or collectively further operable to execute the code to cause the UE to:
receive control signaling indicating one or more sequence indexes including at least the sequence index and one or more corresponding sets of wake up signal skipping parameters.

10. The UE of claim 2, wherein the low power wake up signal indicates an identifier of the UE, a group identifier corresponding to a plurality of UEs, a cell identifier, a tracking area identifier, or any combination thereof.

11. The UE of claim 1, wherein, to receive the signal, the one or more processors are individually or collectively operable to execute the code to cause the UE to:
receive, via the main radio of the UE, a control signal indicative that the UE is to skip use of the low power radio to monitor the one or more low power wake up signals.

12. The UE of claim 11, wherein the one or more processors are individually or collectively further operable to execute the code to cause the UE to:
receive a low power wake up signal during a low power wake up signal monitoring occasion indicated by the control signal, wherein powering down the low power radio is based at least in part on receiving the low power wake up signal.

13. The UE of claim 11, wherein the one or more processors are individually or collectively further operable to execute the code to cause the UE to:
power down the main radio based at least in part on receiving the control signal without receiving a downlink data message associated with the control signal.

14. The UE of claim 1, wherein, to skip the monitoring, the one or more processors are individually or collectively operable to execute the code to cause the UE to:
skip the monitoring of the one or more low power wake up signals based at least in part on non-receipt of a threshold quantity of consecutive low power wake up signals.

15. The UE of claim 1, wherein the signal indicates a pattern for skipping monitoring of the one or more low power wake up signals, a duration for skipping monitoring of the one or more low power wake up signals, or one or more low power wake up signal monitoring occasions, or any combination thereof.

16. The UE of claim 1, wherein, to skip the monitoring, the one or more processors are individually or collectively operable to execute the code to cause the UE to:
skip a plurality of low power wake up signals, wherein the signal is indicative of a quantity of the plurality of low power wake up signals.

17. The UE of claim 1, wherein the one or more processors are individually or collectively further operable to execute the code to cause the UE to:
receive an indication to resume monitoring of low power wake up signals; and
monitor for the low power wake up signals based at least in part on the indication to resume monitoring.

18. The UE of claim 1, wherein the one or more processors are individually or collectively further operable to execute the code to cause the UE to:
transmit a request for the signal indicative that the UE is to skip use of the low power radio to monitor the one or more low power wake up signals, wherein the signal is received based at least in part on the request.

19. The UE of claim 18, wherein the request is transmitted based at least in part on a battery state of the UE, traffic conditions at the UE, or both.

20. A network entity, comprising:
one or more memories storing processor-executable code; and
one or more processors coupled with the one or more memories and individually or collectively operable to execute the code to cause the network entity to:
transmit, to a user equipment (UE) equipped with a low power radio and a main radio, a signal indicative that the UE is to skip use of the low power radio to monitor one or more low power wake up signals; and
refrain from transmitting the one or more low power wake up signals to the low power radio of the UE based at least in part on transmitting the signal.

21. The network entity of claim 20, wherein, to transmit the signal, the one or more processors are individually or collectively operable to execute the code to cause the network entity to:
transmit, to the low power radio of the UE, a low power wake up signal indicative that the UE is to skip use of the low power radio to monitor the one or more low power wake up signals.

22. The network entity of claim 21, wherein the low power wake up signal is transmitted via one or more resources, and one or more indexes of the one or more resources indicate to skip use of the low power radio to monitor the one or more low power wake up signals.

23. The network entity of claim 22, wherein the one or more resources correspond to time resources, frequency resources, spatial resources, or any combination thereof.

24. The network entity of claim 22, wherein the one or more processors are individually or collectively further operable to execute the code to cause the network entity to:
transmit control signaling indicating a plurality of resources including the one or more resources, wherein the low power wake up signal is transmitted via the one or more resources based at least in part on the control signaling.

25. The network entity of claim 21, wherein the low power wake up signal comprises a sequence, and a sequence index of the sequence indicates to skip use of the low power radio to monitor the one or more low power wake up signals.

26. The network entity of claim 25, wherein the one or more processors are individually or collectively further operable to execute the code to cause the network entity to:
transmit control signaling indicating one or more sequence indexes including at least the sequence index and one or more corresponding sets of wake up signal skipping parameters.

27. The network entity of claim 21, wherein the low power wake up signal indicates an identifier of the UE, a group identifier corresponding to a plurality of UEs, a cell identifier, a tracking area identifier, or any combination thereof.

28. The network entity of claim 20, wherein, to transmit the signal, the one or more processors are individually or collectively operable to execute the code to cause the network entity to:
transmit, to the main radio of the UE, a control signal indicative that the UE is to skip use of the low power radio to monitor the one or more low power wake up signals.

29. A method for wireless communications at a user equipment (UE), comprising:
receiving, via a low power radio of the UE or a main radio of the UE, a signal indicative that the UE is to skip use of the low power radio to monitor one or more low power wake up signals; and
skipping monitoring of the one or more low power wake up signals based at least in part on the signal.

30. A method for wireless communications at a network entity, comprising:
transmitting, to a user equipment (UE) equipped with a low power radio and a main radio, a signal indicative that the UE is to skip use of the low power radio to monitor one or more low power wake up signals; and
refraining from transmitting the one or more low power wake up signals to the low power radio of the UE based at least in part on transmitting the signal.
